(19) United States
(12) Patent Application Publication
(10) Pub. No.: US 2015/0178865 A1
(43) Pub. Date: Jun. 25, 2015

(54) TOTAL PROPERTY OPTIMIZATION SYSTEM FOR ENERGY EFFICIENCY AND SMART BUILDINGS

(71) Applicant: The Trustees of Columbia University in the City of New York, New York, NY (US)

(72) Inventors: Roger N. Anderson, New York, NY (US); Albert Boulanger, New York, NY (US); Vaibhav Bhandari, San Francisco, CA (US); Eugene Boniberger, New York, NY (US); Ashish Gagneja, Plainsboro, NJ (US); John Gilbert, New Rochelle, NY (US); Arthur Kressner, Westfield, NJ (US); Ashwath Rajan, San Francisco, CA (US); David Solomon, New York, NY (US); Jessica Forde, Scarsdale, NY (US); Leon L. Wu, New York, NY (US); Vivek Rathod, Mountain View, CA (US); Kevin Morenski, New York, NY (US); Hooshmand Shokri, New York, NY (US)

(73) Assignee: The Trustees of Columbia University in the City of New York, New York, NY (US)

(21) Appl. No.: 14/341,718

(22) Filed: Jul. 25, 2014

Related U.S. Application Data
(63) Continuation-in-part of application No. 14/203,151, filed on Mar. 10, 2014.
Application No. 14/203,151 is a continuation of application No. PCT/US2012/056321, filed on Sep. 20, 2012.
(60) Provisional application No. 61/858,905, filed on Jul. 26, 2013.
(60) Provisional application No. 61/536,930, filed on Sep. 20, 2011.
(60) Provisional application No. 61/638,965, filed on Apr. 26, 2012.
(60) Provisional application No. 61/672,141, filed on Jul. 16, 2012.

(51) Int. Cl. G06Q 50/16; G06Q 10/06; G05B 15/02

(52) U.S. Cl. CPC G06Q 50/163; G05B 15/02; G06Q 10/06315

(57) ABSTRACT

Techniques for managing one or more buildings, including collecting historical building data, real-time building data, historical exogenous data, and real-time exogenous data and receiving the collected data at an adaptive stochastic controller. The adaptive stochastic controller can generate at least one predicted condition with a predictive model. The adaptive stochastic controller can generate one or more executable recommendations based on at least the predicted conditions and one or more performance measurements corresponding to the executable recommendations.

### CROSS-REFERENCE TO RELATED APPLICATIONS

This application claims the benefit of Provisional Application Ser. No. 61/858,905, filed on Jul. 26, 2013, and is a continuation-in-part of U.S. patent application Ser. No. 14/203,151, filed on Mar. 10, 2014, which is a continuation of International Application No. PCT/US12/056,321, filed Sep. 20, 2012, which claims priority to U.S. Provisional Application Ser. No. 61/536,930, filed on Sep. 20, 2011, U.S. Provisional Application Ser. No. 61/638,965, filed on Apr. 26, 2012, and U.S. Provisional Application Ser. No. 61/672,141, filed on Jul. 17, 2012, which are each incorporated herein by reference in their entirety and from which priority is claimed.

### BACKGROUND

The disclosed subject matter relates to techniques for improving the efficiency and reliability of the operation of buildings and/or collections of buildings held by a property owner.

Building energy use can be measured by total electricity, steam and natural gas consumption over a period of time, for example in kilowatt-hours (kWh) per month. The kilowatt-hour can serve as a billing unit for energy delivered to consumers by electric utilities. The energy demand of a building can be measured by the rate of energy consumption by the building. Because energy use fluctuates during the week due to tenant activities and building operation schedule, energy demand can be a more fine-grained measure of building energy use than the aggregate kilowatt-hours consumed during the whole period. The lease obligation of a building owner to tenants can be focused on comfort, with bounding limits often set for temperature, humidity, and air quality, while also increasingly heeding environmental mandates and incentives.

In addition to cost of energy consumption, the cost of steam consumption can depend not only on the total usage but also additional on-peak fees. For example, in New York City, additional on-peak fees of up to $1700/mlb/hr can be applicable to the total of the peak steam demanded between the hours of 6 and 11 in the morning every month from December to March, as the workday begins. To reduce this charge, building operators can store energy as hot water in riser pipes before peak time.

Commercial and residential buildings can be designed for tenant comfort, energy efficiency and system reliability in mind with the use of energy-efficient materials and Building Management Systems (BMS). For example, BMS can integrate a number of Heating Ventilation & Air Conditioning (HVAC) components to assist building operators with maintenance and operation. However, the BMS may not also integrate other building sub-systems that can include lighting systems, elevator management systems, power quality systems, fire system, security systems, and the like. In certain circumstances, BMS can be used to retrieve building energy-related data, such as data reading from sub-meters and sensors. Such systems can be operated in such a manner as to reduce costs of operation while maintaining quality of comfort for tenants, and in some circumstances to comply with mandates or incentives from local, state, and federal governmental regulation. However, BMSs do not always guarantee tenant comfort and reliable building operation because they do not measure or provide visibility and data analytics of space temperatures and occupancy variations sufficiently. New buildings often consume energy at levels that exceed design specifications and system failures can sometimes occur after new equipment is first being put into use.

Accordingly there is a need for improved techniques for improving the comfort, energy efficiency, resiliency and reliability of building operations and management and drive towards a continuous commissioning of the building through its lifetime.

### SUMMARY

The disclosed subject matter relates to techniques for improving the efficiency and reliability of the operation of buildings and/or collections of buildings held by a property owner.

In one aspect of the disclosed subject matter, methods for managing one or more buildings are provided. In an example embodiment, a method can include collecting historical building data, real-time building data, historical exogenous data, and real-time exogenous data from subsystems of the building. The method can include receiving the collected data at an adaptive stochastic controller, and with the adaptive stochastic controller: identifying trends based on the collected data of the one or more buildings. The method can also include using the adaptive stochastic controller for generating a predicted condition with a predictive model, and generating executable recommendations based on the predicted condition and performance measurements corresponding to the executable recommendations. The method can further include displaying the one or more trends based on the collected data of the one or more buildings, the one or more predicted conditions, and the one or more executable recommendations, and/or communicating with the one or more buildings' HVAC systems to manually or automatically steer a floor condition of the said one or more buildings in response to the one or more trends, predicted conditions, or executable recommendations displayed on the graphical user interface.

In certain embodiments, the predicted condition can include one or more of a predicted space temperature, supply air temperature, return air temperature, chilled water temperature, electric load, steam or other fuel consumption, and occupancy in total and by floor. Collecting data can further include receiving from a building management system the historical building data, real-time building data, historical exogenous data, and real-time exogenous data, and wherein the historical building data and the real-time building data includes electric data, fuel and steam data, space temperature information, air flow rate data, chilled water temperature data, supply air temperature information, return air temperature information, lighting sensor data, elevator data, carbon dioxide data, occupancy data in total and by floor, and HVAC system control data. Additionally and/or alternatively, collecting data can include querying one or more databases including the historical building data, real-time building data, historical exogenous data, and real-time exogenous data, and forecasts thereof.

In certain embodiments, the method can include identifying trends in the one or more building conditions and generating a predicted condition for each building condition. The identified trends and the predicted conditions can be displayed and an operator can be alerted when an anomaly between the predicted conditions and the building conditions arises. The one or more building conditions can include space temperature at each measurement location of each floor in the one or more buildings.

In another aspect of the disclosed subject matter, a method for managing one or more buildings can include collecting historical building data, real-time building data, historical exogenous data, and real-time exogenous data, and forecasts thereof. The collected data can be received at an adaptive stochastic controller. The adaptive stochastic controller can generate a predicted condition with a predictive model, and/or generate one or more executable recommendations. Such recommendations can include generating at least one of a recommended preheat time in the winter, start-up time, lunchtime ramp-down and then ramp-up, and afternoon ramp-down time as the tenants leave the building or buildings completing the workday, for a HVAC system and variable frequency drives (VFD) controlling fans, motors and other subsystems based on at least the trends in the one or more building conditions, and generating a one or more preheat, start-up, lunch ramp-down and ramp-up, and afternoon ramp-down conditions at the end of the workday.

In certain embodiments, generating one or more executable recommendations can further include generating at least one of a recommended start-up time and ramp-down time for a HVAC system based on at least the trends in the one or more building conditions, the predicted conditions, and the performance measurements. Generating the one or more preheat conditions can include reducing costs of steam and electricity consumption determined by applying the collected data and the one or more predicted conditions to a dynamic programming model before energy consumption penalties kick-in.

In another aspect of the disclosed subject matter, systems for managing one or more buildings are provided. In an example embodiment, a system can include a data collector to collect historical building data, real-time building data, historical exogenous data, and real-time exogenous data and an adaptive stochastic controller operatively coupled to the data collector and adapted to receive collected data therefrom. The adaptive stochastic controller can be configured to generate at least one predicted condition. The system can include at least one communications module communicatively coupled the data collector, the adaptive stochastic controller, and a System Integration Facility server via a bi-directional messaging interface, and can include a processor and a memory having computer-executable instructions. When executed by the processor, the computer-executable instructions can cause the processor to receive data from the System Integration Facility server, convert the data from the System Integration Facility server and the collected data to a standardized format, store the data from the System Integration Facility server and in a database, send the collected data and the data from the System Integration Facility server to the adaptive stochastic controller to generate the at least one predicted condition, store the at least one predicted condition in the database, and send the at least one predicted condition to the System Integration Facility server.

In certain embodiments, the communications module can maintain a connection to the System Integration Facility server by one or more of a handshake and heartbeat protocol. The predicted condition can include one or more of space temperature, supply air temperature, chilled water temperature, electric load, steam consumption or fuel consumption. In certain embodiments, the data collector can be operatively coupled to a building management system, and the historical building data and the real-time building data can include data from at least one of electric meters, fuel and steam sub-meters, chilled water temperature sensors, space temperature and humidity sensors, supply air temperature and humidity sensors, air flow rate sensors, return air temperature and humidity sensors, or carbon dioxide sensors. The adaptive stochastic controller can be further configured to generate at a recommended start-up time and/or a ramp-down time.

### BRIEF DESCRIPTION OF THE DRAWINGS

FIG. 1 is a block diagram of a system for control and workflow management of a cyber-physical system.

FIG. 2 is a block diagram of a system for control of a cyber-physical system in accordance with the disclosed subject matter.

FIG. 3 is a block diagram of a system for managing one or more buildings in accordance with an embodiment of the disclosed subject matter.

FIG. 4 depicts an exemplary display and a user interface in accordance with an embodiment of the disclosed subject matter.

FIG. 5 is a flow diagram of a method for management of one or more buildings in accordance with an embodiment of the disclosed subject matter.

FIG. 6 depicts another user interface in accordance with an embodiment of the disclosed subject matter.

FIG. 7 depicts another user interface in accordance with an embodiment of the disclosed subject matter.

FIG. 8 depicts another user interface in accordance with an embodiment of the disclosed subject matter.

FIG. 9 depicts another user interface in accordance with an embodiment of the disclosed subject matter.

FIG. 10 depicts another user interface in accordance with an embodiment of the disclosed subject matter.

FIG. 11 depicts another user interface in accordance with an embodiment of the disclosed subject matter.

FIG. 12 depicts the results of an excremental example of an embodiment of the disclosed subject matter.

FIG. 13 depicts the an example of predicted building conditions versus actual recorded building conditions using steering in accordance with an embodiment of the disclosed subject matter.

FIG. 14 illustrates resulting usage of an exemplary embodiment in accordance with the disclosed subject matter in an engine room of an exemplary high-rise office building.

FIG. 15 illustrates an example of the disclosed subject matter for preheating floors of an exemplary building.

FIG. 16 illustrates steam cost and penalty cost for Preheat during building start-up days in accordance with an embodiment of the disclosed subject matter and similar weather days that did not use preheating.

FIG. 17 is a block diagram of an arrangement of modules in accordance with an embodiment of the disclosed subject matter.

FIG. 18 illustrates the determination of floor-by-floor occupancy in accordance with an exemplary embodiment of the disclosed subject matter.

FIG. 19 illustrates estimated and actual floor-by-floor occupancy in accordance with an exemplary embodiment of the disclosed subject matter.

Throughout the drawings, the same reference numerals and characters, unless otherwise stated or indicated by context, are used to denote like features, elements, components or portions of the illustrated embodiments. Moreover, while the disclosed subject matter will now be described in detail with reference to the Figs., it is done so in connection with the illustrative embodiments.

### DESCRIPTION

Commercial office buildings or multi-unit residential buildings can experience energy consumption that exceeds specifications and system failures. Disclosed herein are techniques for improving comfort, energy efficiency and reliability of building operations without the need for large additional capital investments. For purpose of illustration and not limitation, the techniques disclosed herein can use a machine learning predictive model to generate energy demand forecasts and automated analysis that can guide optimization of building operations to improve tenant comfort while improving energy efficiency. An automated online evaluation system can monitor efficiency at multiple stages in the system workflow and provide operators with continuous feedback, for example, to evaluate operator actions if the operator deviates from a recommendation generated by the techniques disclosed herein. A user interface can be provided to display a representation of the building conditions, predicted conditions, and executable recommendations.

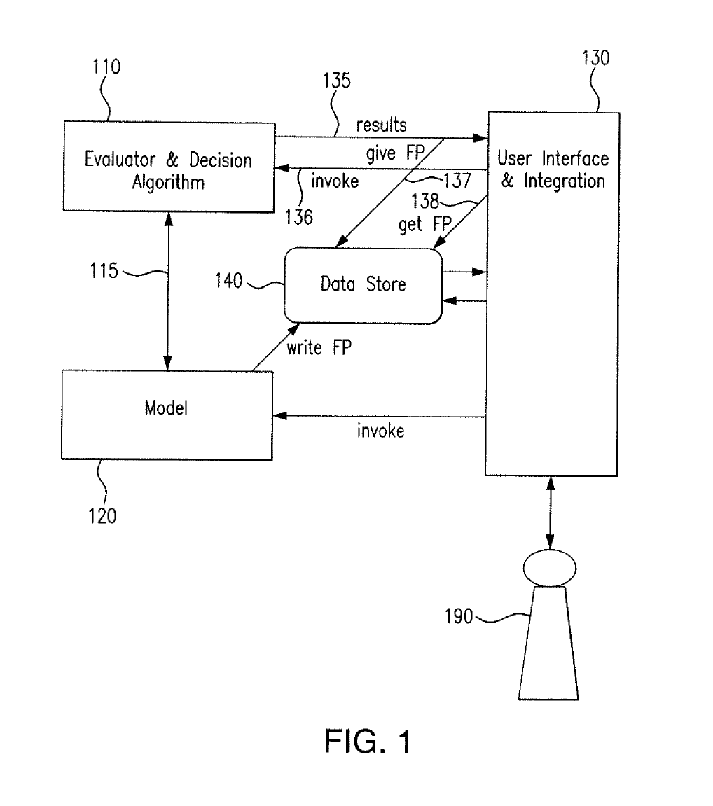

Controlling and managing one or more buildings, like other cyber-physical systems, can be a multistage, time-variable, stochastic optimization endeavor. Adaptive Stochastic Control (ASC) using, for example, approximate dynamic programming (ADP) can offer the capability of achieving autonomous control using computational learning systems to manage the building systems. Additionally, as used herein, the term “Adaptive Stochastic Control” can include a number of decision techniques, such as methods based on a rule based system, neural network, fuzzy logic control, model predictive control, stochastic programming, linear programming, integer programming, mixed integer nonlinear programming, machine learning classifier, logistic regression, or the like, and/or any combination thereof. For purpose of illustration and not limitation, and with reference to FIG. 1, an exemplary system for controlling and managing workflow in a cyber-physical system can include a user interface 130 integrated with and operatively coupled to a number of modules. For example, the user interface 130 can be coupled to an evaluator and decision algorithm 110, a model 120, and a data store 140 using a network, bus, or other suitable communications medium.

The user interface 130 can be configured to communicate with the evaluator and decision algorithm 110 so as to receive results 135 and send data 136 which can be obtained from the data store 140. In like manner, the user interface 130 can be configured to communicate with the data store 140 to send and receive data, e.g. failure probability prediction (FP) data 138 and 137. Additionally, the user interface 130 can be configured to invoke a model 120. The model 120 can be operatively connected, for example via a wired, wireless, or flat file communication protocol 115, with the evaluator and decision algorithm 110. A user 190 can operate and interact with the user interface 130 to facilitate control and management of the cyber-physical system. As described in more detail herein, the modules 110 and 120 can be selected based on a desired task.

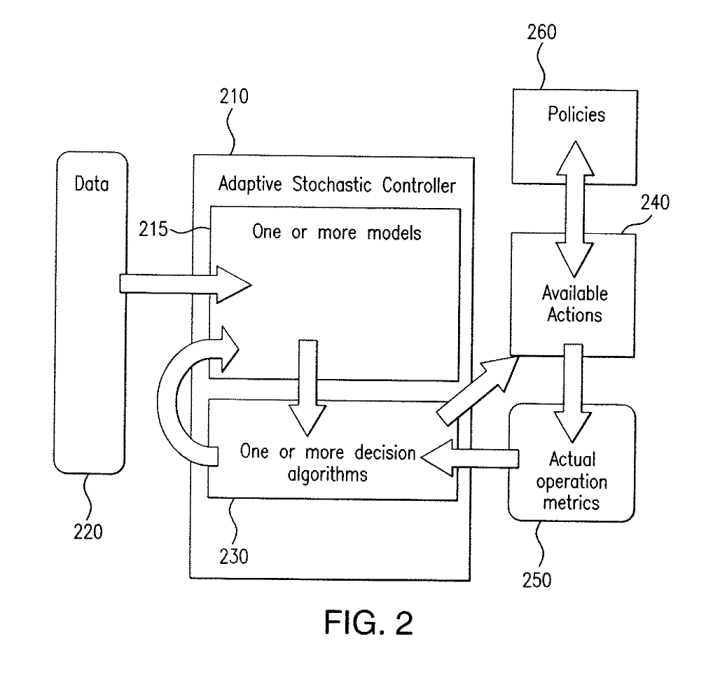

For purposes of illustration and not limitation, a system for managing a cyber physical system can have a framework such as the one depicted in FIG. 2. Generally, data representative of a cyber-physical system 220 can be collected. The data 220 can be processed and formatted and can be stored, for example, in one or more databases. For example, the data 220 can be collected with a data collector, which can include a computer programmed to interface with and receive the data internally from the cyber-physical system or from a remote system. That is, the cyber-physical system or a remote system can transmit (330) the data to the data collector, which can then store the data 220 in a database.

An adaptive stochastic controller 210 can be operatively coupled to the data collector and adapted to receive collected data 220 from the data collector. As used herein, the term “adaptive stochastic controller” can include a controller that can simulate multiple potential future outcomes in order to quantify uncertainty and adapt desired actions and policies. For example, as described herein, an adaptive stochastic controller can use approximate dynamic programming to predict emerging problems and recommend operational actions to enhance performance, and can include verification, e.g., via feedback, of one or more predictive models. Further, as described herein, an adaptive stochastic controller, e.g., via feedback and being online, can auto-correct and employ machine learning to modify actions taken on the system over time as external forces change. That is, for example, an adaptive stochastic controller can measure cause-and-effect and adjust learning accordingly.

The adaptive stochastic controller 210 can include, for example, an innervated stochastic controller such as disclosed in U.S. Pat. No. 7,395,252. Additionally or alternatively, the adaptive stochastic controller 210 can include a machine learning and/or statistical modeling element. For example, the adaptive stochastic controller 210 can include a machine learning element employing martingale boosting such as disclosed in U.S. Pat. No. 8,036,996, which is hereby incorporated by reference in its entirety. Additionally or alternatively, the adaptive stochastic controller 210 can include an element utilizing a technique based on a rule based system, neural network, fuzzy logic control, model predictive control, stochastic programming, linear programming, integer programming, mixed integer nonlinear programming, machine learning classifier, logistic regression, or a combination thereof.

One or more of the recommended actions 240 can be generated. For example, element 230 can generate a set of proposed actions 240 which can then be executed manually. Alternatively, such proposed actions can be executed in an autonomous manner. After an action 240 has been executed, metrics 250 of the cyber-physical system can be collected. The metrics 250 can include, for example, information regarding the state of the cyber-physical system, the components of the cyber-physical system, as well as external information. Moreover, the metrics 250 can include predictions as well as data generated by a model. The actual operation metrics 250 can include data analogous to data 220. That is, data 220 can be a subset of the actual operation metrics 250. Additionally or alternatively, data 220 can represent a measurement that can be altered by a change in operation under the control of the adaptive stochastic controller 210.

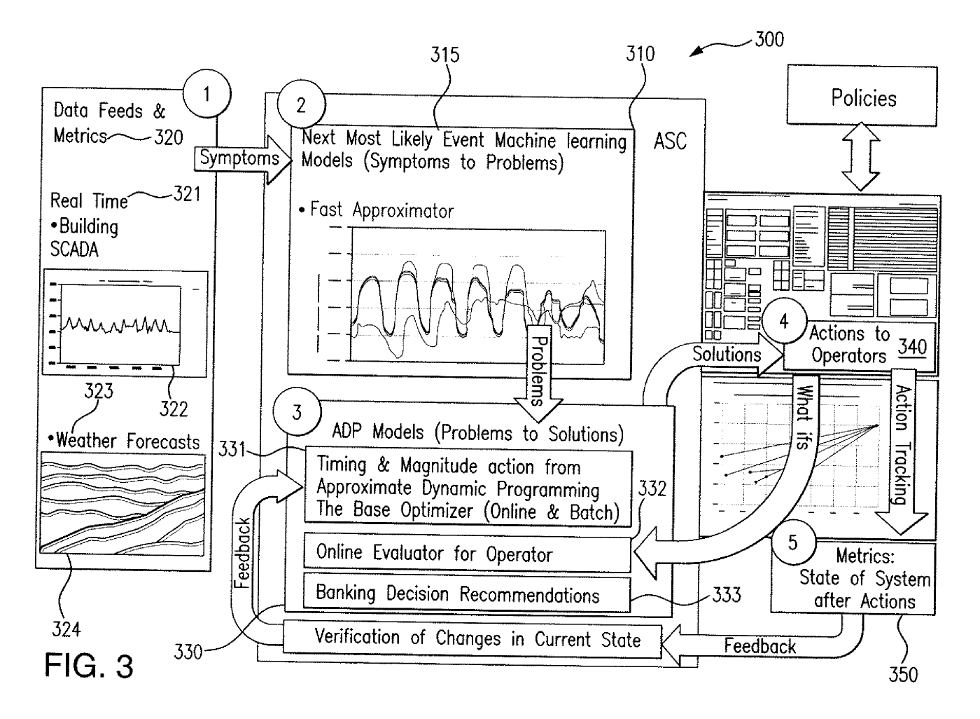

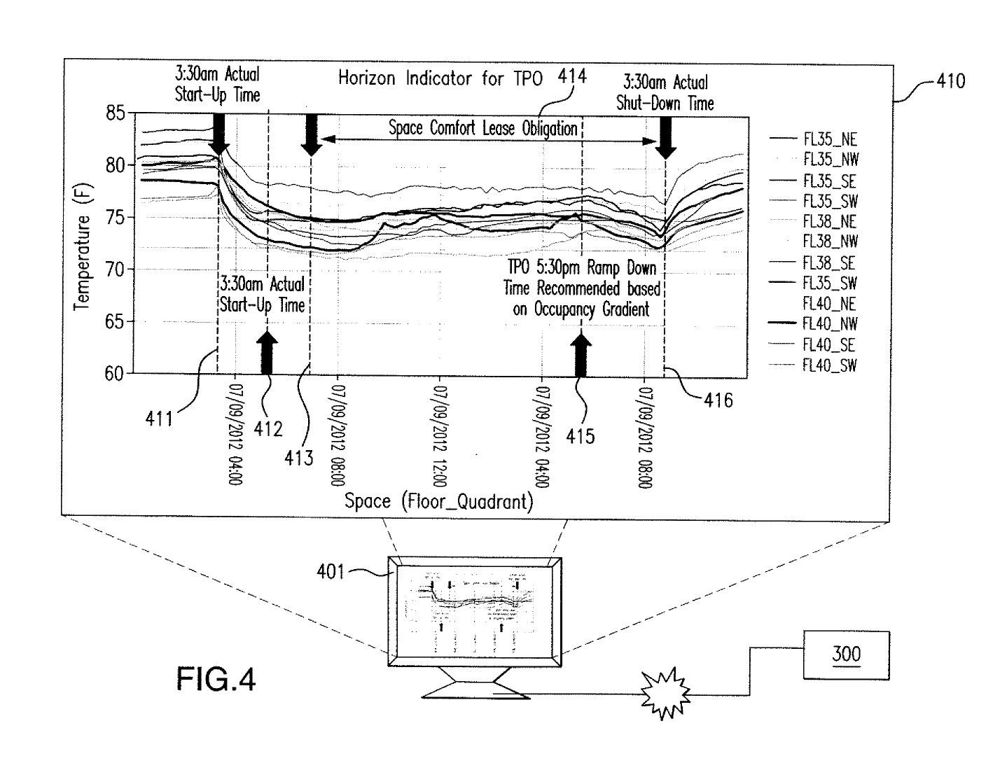

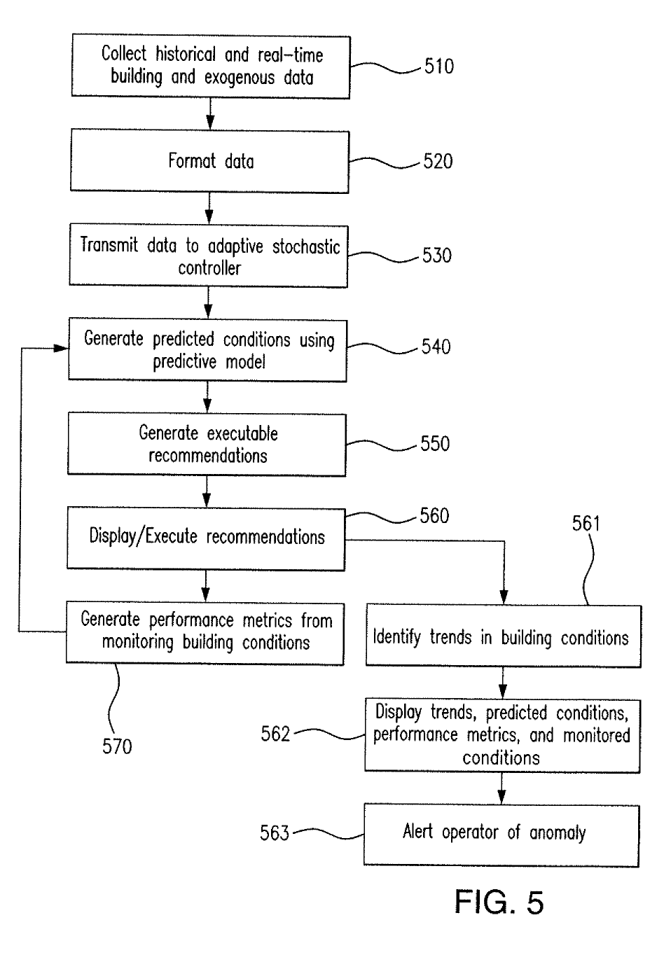

Particular embodiments of the system and method are described below, with reference to FIG. 3, FIG. 4, and FIG. 5, for purpose of illustration and not limitation. For purpose of clarity, the method and system are described concurrently and in conjunction with each other. The system and methods described below can be referred to as the “Total Property Optimization” system.

In an exemplary embodiment, techniques for managing one or more buildings can include collecting (510) historical building data 322, real-time building data 321, historical exogenous data 323, and real-time exogenous data 324 with a data collector 320. The historical and real-time building data can include, for example, all Building Management System data (BMS) data and other building information, including without limitation data from lighting systems, air conditioning, heating systems, elevator management systems, power systems, fire systems, security systems and the like. The historical and real-time exogenous data can include, for example, weather data (historical and forecast), power grid data, energy data such as steam and natural gas usage, tenant-by-tenant occupancy over time, and lease requirements such as comfortable space temperature information during working hours and what the working hours are. Weather data can include, for example, temperature information (including humidity data) for both the interior and exterior of buildings, forecasts of day-ahead temperature and humidity changes, wind and storm magnitudes and trajectories.

The historical and real-time building data can also include building energy use data, which can be provided, for example, from Building Management System (BMS), Elevator Information Management System (SIMS) and Energy Management System (EMS). BMS can collect data from, among other things, electric, gas and steam sub-meters and space temperature information, HVAC equipment measurements such as air flow rates, supply air temperature information, return air temperature information, and various environmental sensors such as carbon dioxide content of the return air. The historical and real-time data can also include power grid data, including for example, electrical demand and consumption, peak historical and future predicted loads, electric power quality, including frequency and voltage, steam generation and consumption, fossil fuel (including without limitation heating oil and natural gas) usage and pricing, and power failure warnings. Such data can be transmitted electronically from a utility company, for example, via a web portal or email, or sensed by low voltage power quality measurement systems, smart meters or electric power consumption meters, or analogous steam and fuel consumption meters, that provide external signals inside the building or buildings.

The collected data 320 can be formatted (520), for example with a preprocessor. For example, weather and power grid data can be combined with building energy usage, occupancy variations by floor, space temperature information, supply and return air temperature information and chilled water return temperatures in a data aggregator. A data preprocess can clean and format the data for normalization. In an exemplary embodiment, the data can be normalized between a value of 0 and 1 for equal weighting. Additionally, data can be converted into consistent units of measurement. In certain embodiments, the preprocessor can also handle missing data by imputing values and correct for outliers and/or interpolate/extrapolate data in time or space.

The collected data 320 can be received (i.e., transmitted to) (530) at an adaptive stochastic controller 310, and the adaptive stochastic controller 310 can generate (540) a predicted condition with a predictive model 315. The predictive model 315 can be, for example, a predictive machine learning model. Additionally or alternatively, the predictive model 315 can be a model based on a first-principles physics model, neural network, statistical auto-regression, machine learning regression, statistical regression, or a combination thereof. The predicted condition can be, for example, a predicted condition or forecast over a predetermined period, such as a day, a week, a month, or the like. The predicted condition can be, for example, predicted space temperature, supply air temperature, chilled water temperature, electric load, steam consumption or fuel consumption. Additionally or alternative, the predicted condition, with respect to conditions involving energy usage, can be given in units of instantaneous energy demand rather than, e.g., average kilowatt-hours, to allow for highly granular measurements. Certain machine learning techniques can be employed to generate the predicted condition, such as but not limited to neural networks, statistical auto-regression techniques such as Seasonal Auto Regressive Integrated Moving Average (SARIMA) and Bayesian Additive Regression Trees (BART), and Support Vector Machines (SVMs). Martingale boosting such as disclosed in U.S. Pat. No. 8,036,996 or Adaptive Stochastic Control using Approximate Dynamic Programming such as disclosed in U.S. Pat. No. 7,395,252 can be used in connection with the predictive model. Additionally and/or alternatively, other machine learning algorithms disclosed elsewhere herein can be used in connection with the generation of executable recommendations.

The adaptive stochastic controller 310 can further generate (550) one or more executable recommendations 340 with a decision algorithm 330 based on at least the predicted conditions and one or more performance measurements 350 corresponding to the executable recommendations 340. The decision algorithm 330 can be, for example, a rule based system, approximate dynamic programming (ADP), linear programming, neural network, fuzzy logic control, model predictive control, stochastic programming, linear programming, integer programming, mixed integer nonlinear programming, machine learning classifier, logistic regression, or a combination thereof. In one embodiment, for example, the decision algorithm 330 can receive the collected data 320 and the output of the predictive model 315. Business knowledge support rules, constraints, priorities, mutual exclusions, preconditions, and other functions can be applied to the data 320 to derive executable recommendations 340 for each building or collections of buildings.

The executable recommendations 340 can be, for example, inspection orders, repair orders, work schedules, HVAC Start-Up and Ramp-Down times (e.g., as described in more detail below with reference to FIG. 4), and preventative maintenance actions such as those embodied in U.S. Pat. No. 7,945,524, which is hereby incorporated by reference in its entirety. In one embodiment, the decision algorithm 330 can include a business process management component (BPM) and a business rules management component (BRM), which can interact with each other while responding to events or executing business judgments defined by business rules or rules induced by machine learning systems. Approximate Dynamic Programming algorithms like those embodied in U.S. Pat. No. 7,395,252, which is incorporated by reference herein, can be utilized in connection with the generation of executable recommendations 340. Additionally and/or alternatively, other machine learning algorithms disclosed elsewhere herein can be used in connection with the generation of executable recommendations.

In one embodiment, the one or more performance measurements 350 can be generated (570) with an automated online evaluator 332 based on at least data from monitoring one or more building conditions. The automated online evaluator 332 can be configured to monitor one or more building's internal and external conditions, operator control actions, and evaluate the results of those operator actions to provide feedback to the adaptive stochastic controller 310. For example, the automated online evaluator 332 can be used to evaluate operator actions that deviate from what the ASC recommends to the operator. In certain embodiments, certain components, such as for example the “Horizon Indicator” as described in more detail below, can detect anomalies in performance of equipment or in external conditions, and automatically display or transmit feedback in the form of customized dashboards for a building operator.

The one or more performance measurements 350 can include, for example, cost benefit analyses evaluating energy efficiency improvements against lease contracts with tenants for the provision of comfort of the building occupants. In certain embodiments, the performance measurements 350 can include a comparison of energy usage for specific tenants so as to enable coordination with their respective secondary heating, cooling, and/or lighting systems to enable additional energy efficiencies. Moreover, the performance measurements 350 can include a scoring and/or relative accuracy rating of forward looking forecasts generated from the predictive model 315.

Additionally or alternatively, the techniques disclosed herein can include displaying (560) on a user interface 410 of a display device 401 trends in the one or more building conditions, the predicted conditions, and/or the one or more executable recommendations 340. Trends in the one or more building conditions can be identified (561) and a predicted condition for each building condition can be generated. The identified trends and the predicted conditions can be displayed (562) so as to alert (563) an operator can when an anomaly between the predicted conditions and the actual building condition arises. For purpose of illustration and not limitation, the building conditions can be, for example, motor load in connection with a HVAC system. The motor load can be predicted and compared to actual motor load conditions, and thus a potential problem can be identified if there is an anomaly. This can enable preventative maintenance of the HVAC system to take place.

In an exemplary embodiment, and with reference to FIG. 4, techniques for building management can include the use of a real time “Horizon Indicator.” For purposes of illustration and not limitation, the Horizon Indicator 410 can be analogized to the display in an airplane cockpit central to the pilots understanding of the condition of the plane relative to the horizon—in the building embodiment, it can be used to detect performance anomalies and show whether one or more buildings are performing as expected.

For example, real-time trending of space temperatures can be reported by the BMS system into the total property optimization system 300 by floor and quadrant (or in certain embodiments, by a finer or courser spatial division). The Horizon Indicator 410, in connection with other components of the total property optimization system 300, such as the predictive model 315 and the automated online evaluator 332, can identify temperature trends and subsequent inspection and repair results and feed them into ASC 310. These trends can be interpreted by components of the ASC 310 as the thermal signature of specific spaces in the building.

The Horizon Indicator 410 can be configured to analyze occupancy patterns, tenant behavior, and characteristics of the space, and can identify tenant behaviors that correspond to changes in temperatures in different spaces (e.g., total tenant space, floors, conference rooms, cubicles, and traditional offices). As the historical record from the Horizon Indicator grows, it can become an empirical database of the effects of architecture, operations, and tenant behavior on the thermodynamic behavior of building spaces. Moreover, the Horizon Indicator can become a record for characterizing normality for the purpose of anomaly detection as described herein.

In one embodiment, the Horizon Indicator can be presented to an operator in the form of a dashboard including the executable recommendations. When the space temperature does not follow its predicted signature, an anomaly can be identified and building operators can be alerted to potential operational problems. Because the Horizon Indicator monitors space temperatures in real time, a recommended change in tenant comfort can be observed within minutes after it is made. Compensatory changes recommended by the TPO system 300 to the building operator can correct a problem before a tenant notices any discomfort. Additionally, the Horizon Indicator and accompanying display can enable an operator to better understand lag times associated with tenant behavior such as occupancy, operational decisions, and temperature changes in spaces throughout buildings.

In accordance with this exemplary embodiment, the automated online evaluator 332 can monitor a building's internal and external conditions, which can include, for example, space temperature by quadrant (or in certain embodiments, by a finer or courser spatial division) on every floor, electric load, peak load predicted time and magnitude, fluctuating electricity pricing, building work and maintenance schedules, and the like. Additionally, the automated online evaluator can monitor the executable recommendations 340 and score the results of those actions, for example where an operator's action deviates from the executable recommendations 340, the actions including for example lighting levels, air conditioning or heat controls, load shedding such as safely shutting off elevators to optimize electrical usage during emergencies, heating ventilation and air conditions (HVAC) system optimization, and tenant comfort level maintenance regardless of occupancy levels on each floor.

For purposes of example, and not limitation, FIG. 4 depicts a user interface 410 on a display device 401 including a display of trends in space temperature per quadrant (or in certain embodiments, by a finer or courser spatial division) of each building floor. The user interface 410 also displays executable recommendations, including recommended start-up time 412 for the HVAC system and recommended ramp-down time 415 for the HVAC system. Executable recommendations 412 and 415 can be generated with the ASC 310 and automatic online evaluator 332 based on, among other things, the space comfort lease obligations 414 and trends in the monitored building conditions. Actual start-up time 411 and actual shut-down and ramp-down time 416 are also displayed on the user interface 410.

With reference to FIG. 4, for example, the Horizon Indicator shows that the HVAC system started up at 3:30 AM and resulted in cooling of the spaces to temperatures that reaches optical comfort values at approximately 5 AM. Thus, the start-up time can be interpreted as too early, for example, where the floors are desired to reach those temperatures only at the 7 AM lease requirement. However, though temperatures remained largely horizontal on certain floors, the southwest quadrant of Floor 35 can be deemed to have been too warm throughout the day.

Additionally, in accordance with this exemplary embodiment, Support Vector Machine Regression (SVR) can be used to build models, including but not limited to Individual Day Models (IDMs) and Individual Hour Models (IHMs), based on learning the historical behavior of the thermodynamics of the building using past history for a particular unit of time, including an hour of the week or an hour of the day. A nonlinear kernel function can allow the fitting of a maximum-margin hyperplane in a transformed feature space. A Gaussian radial basis function can serve as the support vector machine kernel function. The support vector machine can be trained on a training set of data to build a predictive model (e.g., a function that can be used for predicting future values). Additionally, time delay coordinates, derivative coordinates, or other phase space reconstruction methods can be employed in order to create the feature vectors of the support vector machine used for SVR.

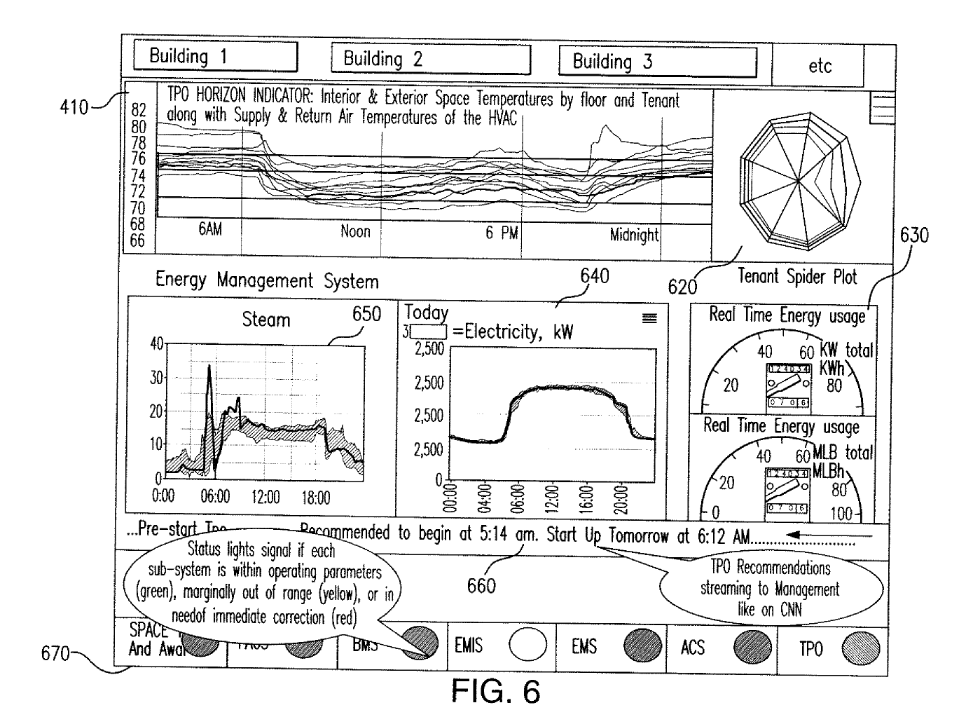

FIG. 6 depicts an exemplary user interface, or “dashboard” in accordance with the disclosed subject matter. The dashboard can include a display of the Horizon Indicator 410, a spider plot 620 of metrics related to tenant occupancy, and a representation of real time energy usage and real time steam usage 630. Additionally, the dashboard can include a display of historical steam usage 650 and electricity usage 640. Executable recommendations 340 can be displayed, for example, in a streaming fashion with a ticker 660. Additionally, the dashboard can include a color coded indication 670 of the status of each subsystem within a building. For example, a green icon can indicate that a particular system is operating within suitable operating parameters, while a red icon can indicate that a system is in need of immediate correction.

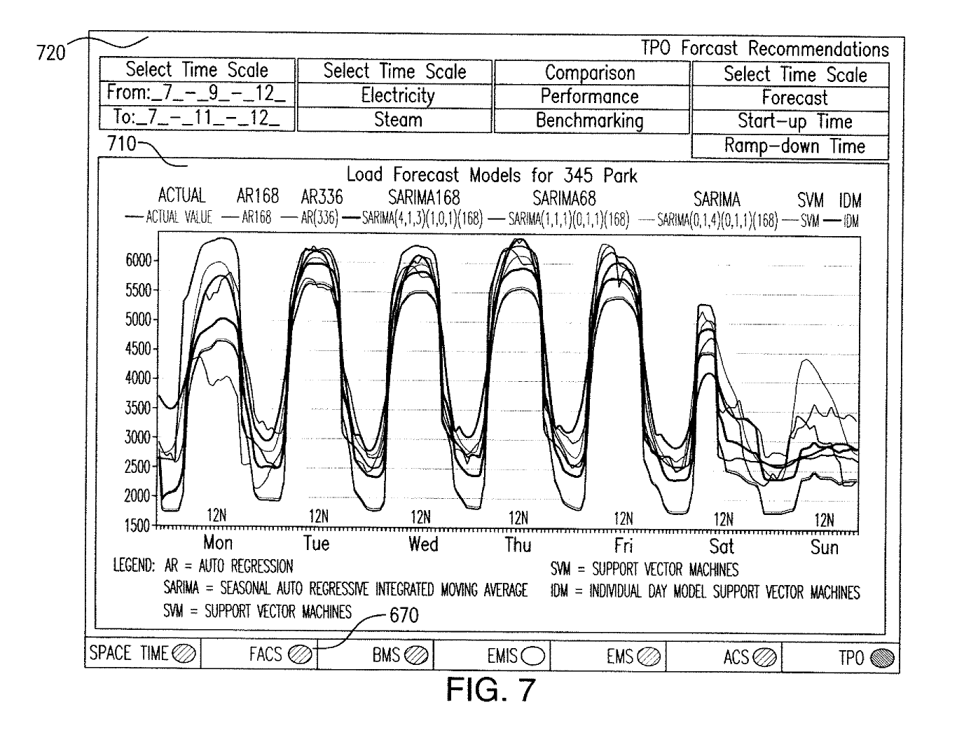

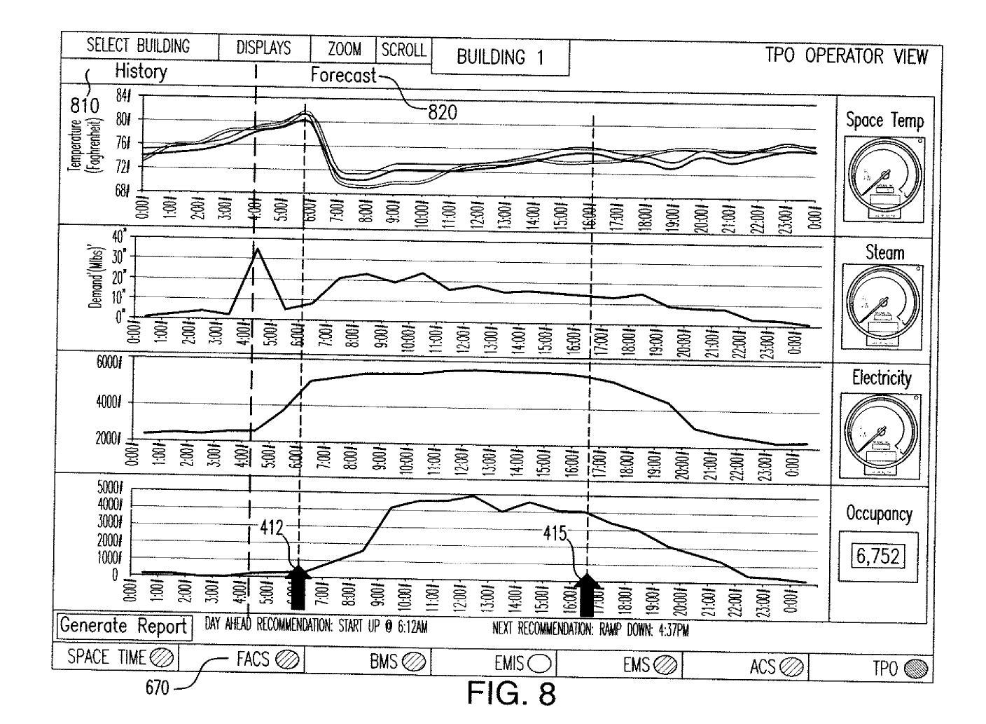

FIG. 7 depicts another exemplary user interface in accordance with the disclosed subject matter. This user interface 720, which is configured to display electric load forecasts, includes the color-coded indication bar 670. Additionally, the load forecast 710 generated, for example, from various configurations of the predictive model 315, can be displayed. In like manner, FIG. 8 depicts another exemplary user interface in accordance with the disclosed subject matter. This user interface can display forecasts and recommendations for an operator for space temperature, steam usage, and electricity usage for an upcoming day (i.e., “day-ahead recommendations”). Historical data 810 is displayed on the left side of the interface, while forecast data 820 is displayed on the right. The executable recommendations 412 and 415 are also displayed.

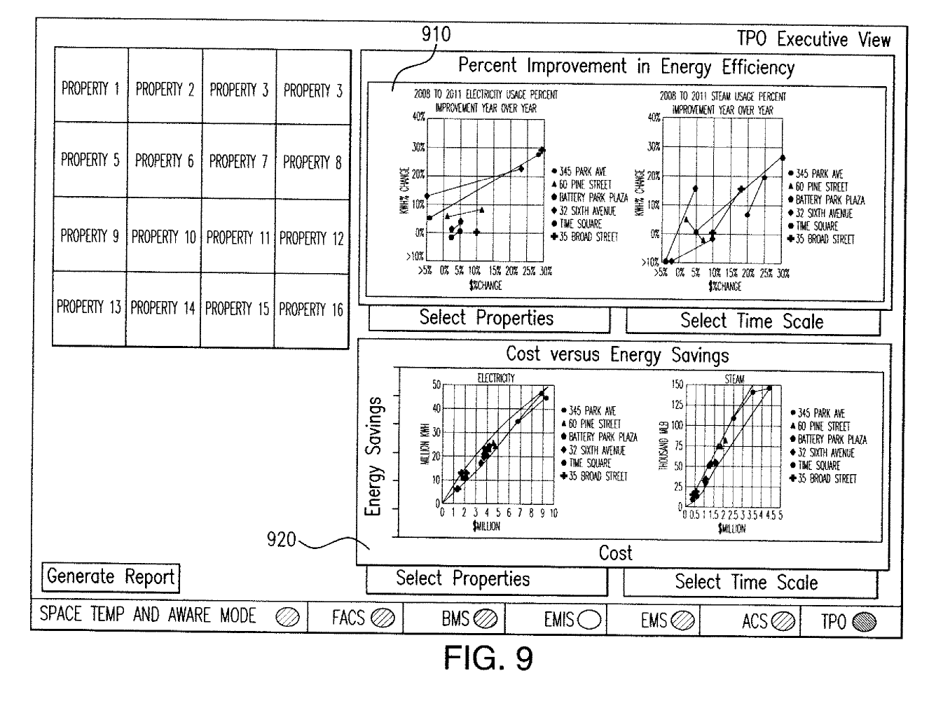

FIG. 9 depicts another exemplary user interface in accordance with the disclosed subject matter. This user interface can display a high level executive view of multiple properties. For each property, curves that illustrate a tradeoff between operating conditions and/or objectives, for example, efficient frontier (Pareto) curves of cost versus benefit 920, efficiency verses performance 910, or the like, can be displayed with the status of each building. For example, in connection with certain embodiments, costs and usage can be normalized into percentages of improvement over the costs and usage of a previous period. If costs increase at a faster rate than efficiency efforts to reduce consumption, overall benefit can be reduced. In this manner, an efficient frontier curve can be displayed in year-over-year percentage improvement, as illustrated in FIG. 9 and as described, for example, in U.S. patent application Ser. No. 13/589,737, which is hereby incorporated by reference in its entirety. As illustrated therein, a baseline state of energy efficiency efforts at initialization time for a set of buildings in a portfolio can be compared to an improvement above the baseline after the techniques of the disclosed subject matter have been employed.

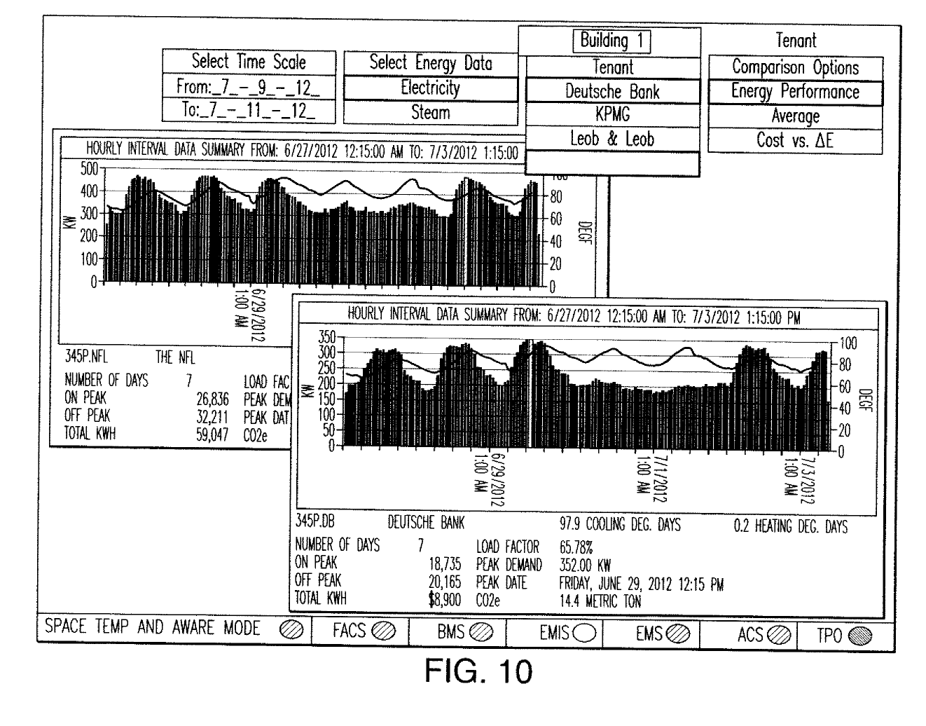

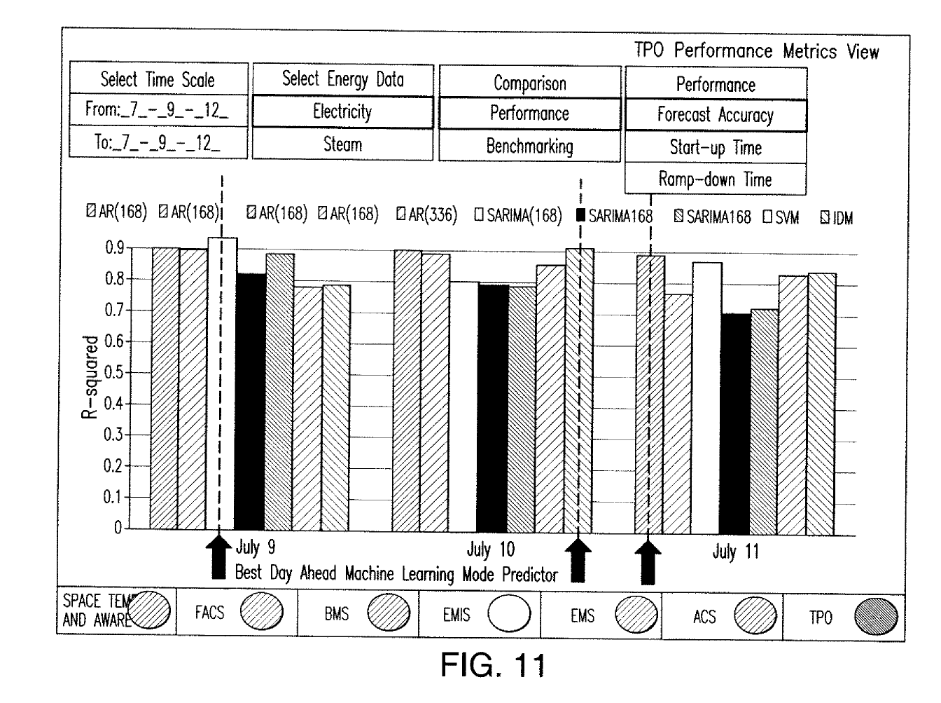

FIG. 10 depicts another exemplary user interface for displaying comparisons of energy usage of specific tenants, which can enable coordination with their secondary heating and cooling systems so as to achieve additional energy efficiencies. FIG. 11 depicts another exemplary user interface for displaying certain performance measurements 340. For example accuracy of predictions can be given by coefficient of determination (R-squared), Root-mean-square deviation (RMSE), Maximum Absolute Percentage Error (MAPE), or the like, and compared.

For purposes of illustration and not limitation, the disclosed subject matter, hereinafter referred to the “Total Property Optimizer” (TPO), will be described in connection with exemplary and non-limiting scenarios. The TPO can combine a variety of machine learning-based optimization and management tools for management of commercial office buildings, such as methods based on a rule based system, neural network, fuzzy logic control, model predictive control, stochastic programming, linear programming, integer programming, mixed integer nonlinear programming, machine learning classifier, logistic regression, or the like, and/or any combination thereof. In an exemplary embodiment, TPO can use Support Vector Machine Regression (SVR) to forecast whether real time data trends for space temperatures (tracks tenant comfort), electric loads, steam, and water usage will be in the desired performance ranges for each major building within a portfolio. A Horizon Indicator can then display historical, real-time and forecast values and provides recommendations when data points are trending towards sub-optimal performance using anomaly detection. For example, by forecasting future space temperatures by floor and quadrant (or in certain embodiments, by a finer or courser spatial division) using SVR, the Horizon Indicator can provide recommendations for next day's start-up and shut down time for the heating, ventilation and air conditioning (HVAC) system and supply air fans. Thus the TPO can allow building operators, engineers, and managers to take pre-emptive actions to keep systems running smoothly. Two exemplary applications are to ensure optimal tenant comfort and efficient energy use.

Horizon Indicator can, for example, compile all available and relevant Supervisory Control and Data Acquisition (SCADA) data points in 5 to 15-minute intervals and display actual and forecast data in real time. It can display weather (forecast and actual), power quality of the electric grid, energy (steam, electric, water, and natural gas), tenant-by-tenant sub-metered electric usage, occupancy and space temperature information in each quadrant (or in certain embodiments, by a finer or courser spatial division) of a building. Other relevant data from the Building Management System (BMS), Elevator Information Management System (EMIS) and Energy Management System (EMS) can also be displayed.

Data points can be displayed independently, but can also be combined to reveal feedback between systems. Optimal value bands for data points that are intended to remain constant, such as space temperature during operating hours, can be determined by lease requirements with tenants. These bands can allow building operators to quickly see how well the building HVAC system is delivering comfortable space temperatures and identify areas of the building that require adjustment or maintenance. Using the historical database in Horizon Indicator, building operators can observe changes in data trends and use this information to identify zones of the building that are not operating optimally and investigate their root causes. Confidence interval bands based on the SVR predictions can be displayed for more dynamic data trends such as steam and electricity. To develop the confidence interval band for electric load, for example, a normal distribution on the forecast error for the SVR training set can be assumed. This normal distribution corresponding to the optimized set of parameters can be used to obtain a 95% confidence interval for forecasts in a test set. The display can also give signals for recommended start-up, ramp-down for a building's HVAC system based on SVR forecasts of space temperature.

In one embodiment, for example, Horizon Indicator can display forecast values for each data point using SVR. The data sets can contain historical data for the data point being modeled and corresponding values for covariates that correlate to the modeled data point. Exemplary covariates are provided in Table 1. The SVR model can produce regressions for each data point, forecasting, for example, the coming 24 hours, recomputed ahead every 15 minutes. These regressions can be updated on the Horizon Indicator interface in real time. Each of the data points can include as covariates many of the other data points, which indicates the feedback that exists between these systems and the desire to present them in a unified interface.

TABLE 1

| Data Point | Covariate 1 | Covariate 2 | Covariate 3 | Covariate 4 | Covariate 5 |
|---|---|---|---|---|---|
| Space | Humidex | Occupancy | Supply Air | Electric | Steam Demand |
| Temperature | | | Temperature | Demand | |
| Electricity | Humidex | Occupancy | Space | Steam | Supply Air |
| | | | Temperature | Demand | Temperature |
| Steam | Humidex | Occupancy | Space | Electric | Supply Air |
| | | | Temperature | Demand | Temperature |
| Occupancy | Space | Electric | Steam | Elevator | Turnstile |
| | Temperature | Demand | Demand | headcounts | counters |

Using forecast space temperatures, the Horizon Indicator can display recommendations of recommended HVAC start-up times. By inputting humidex derived from weather forecasts into the space temperature regression (which can be, e.g., SVR or a linear regression), the forecast can reveal the amount of time it takes each day to reach optimal space temperatures from the time the chiller machines and supply air fans are turned on. Knowing the amount of time it takes to cool or warm the building to a comfortable level, building operators can delay the start time so that the building is comfortable only during hours of the day when spaces are occupied, eliminating excess and wasted energy usage.

In an aspect of the disclosed subject matter, the system can be organized to enable messaging and interactions between the various components via modules designed to send and receive recommendations, predictions, and other data converted into a common format. The system can include a communications module communicatively coupled the data collector, the adaptive stochastic controller, and a System Integration Facility server via a bi-directional messaging interface, and can include a processor and a memory having computer-executable instructions. When executed by the processor, the computer-executable instructions can cause the processor to receive data from the System Integration Facility server, convert the data from the System Integration Facility server and the collected data to a standardized format, store the data from the System Integration Facility server and in a database, send the collected data and the data from the System Integration Facility server to the adaptive stochastic controller to generate the at least one predicted condition, store the at least one predicted condition in the database, and send the at least one predicted condition to the System Integration Facility server.

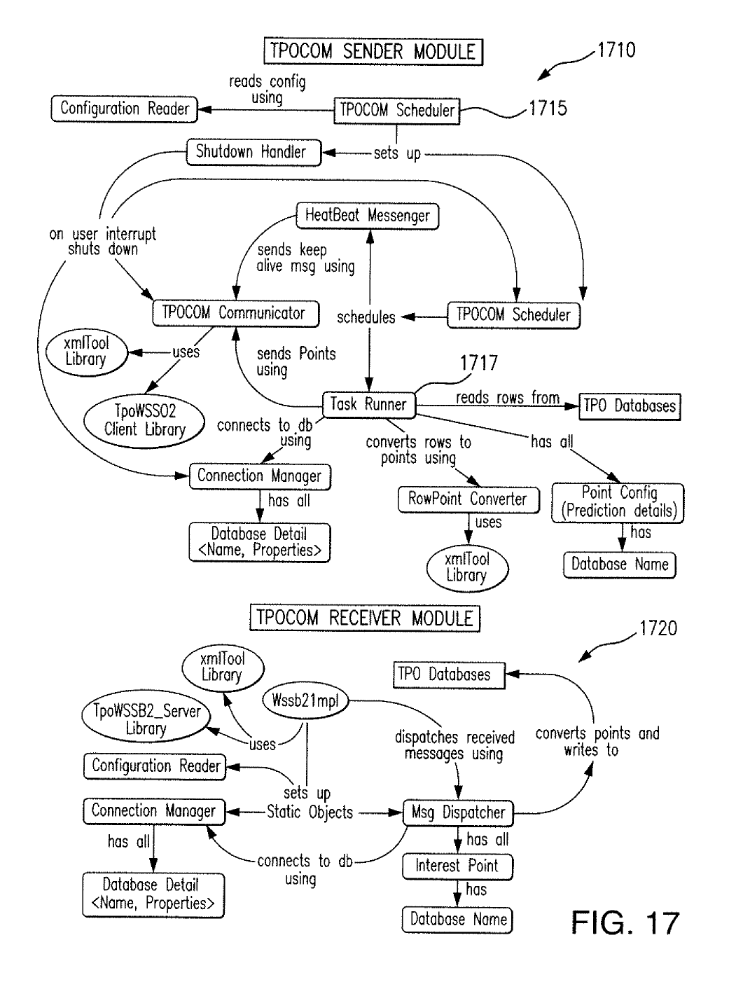

For purpose of illustration and not limitation, and with reference to FIG. 17, an exemplary communications module can include a Sender and a Receiver for messaging and interaction with a System Integration Facility (SIF) central Relational Database (referred to herein, collectively, as “TPOCOM”). In an exemplary embodiment, the Sender can read TPO predictions generated by the TPO and send them to the SIF Server. The SIF Server can receive building sensor data, format this data into a common SIF format, and send the data to the Receiver. In one embodiment, the arrangement of modules is synchronized using heartbeat and handshake protocols.

That is, TPOCOM can include a pair of independent sub-systems referred to as the Sender and the Receiver. TPOCOM Sender reads TPO predictions, recommendations, and alarms generated by TPO analytics and sends/pushes them to the SIF Server. In turn, the SIF Server receives building sensor data from the respective properties, formats this data into a common SIF format, and then pushes the data back to the TPOCOM Receiver.

FIG. 17 illustrates the TPO process flow diagrams for the TPOCOM Sender and Receiver Modules. These diagrams display the internal functions performed supporting Send and Receive between TPO and the SIF server. The TPOCOM Sender can be managed by the TPOCOM Manager, which schedules the Task Runner component to run periodically; the Task Runner can perform the following ordered functions with the other respective TPO components:
Task Runner gets new/updated recommendations/predictions/alarms from the TPO database in which the TPO analytic processes have stored their most recent computed results (data points).
RowPoint conversion converts the data fetched from TPO database into 600 to 800 SIF format data points per hour to be used in reporting recommendations/predictions by TPO analytics. Task Runner interworks with the RowPoint Converter by which prediction data points are formatted and assembled; these data points represent degrees of confidence reported in a graph for the various temperature, energy, and occupancy visualizations predicted/recommended by TPO.
Task Runner then requests TPOCOM to push/send the data to the SIF Server.
Also, the Task Runner maintains a heartbeat handshake protocol with the SIF Server once a minute to keep the connection between SIF and TPOCOM alive.

The TPOCOM Sender can use a set of unique XML libraries to marshal TPO data into SIF data Format. Additionally, the TPOCOM Receiver can respond to Web Service callback events registered to act on receiving data from SIF. The TPOCOM Receiver can call the MSG Dispatcher to begin processing the incoming sensor point and alai′ data received from the SIF; this processing can include:
Parsing incoming SIF points.
De-multiplexing the points based on their identifiers.
Converting them to TPO database format.
Using the Connection Manager to connect to appropriate TPO databases.
Writing the converted points to the TPO databases.

The TPOCOM Receiver can make use of a set of unique XML libraries to parse and process the incoming data from the SIF.

The non-limiting arrangement of FIG. 17, hereinafter referred to (“TPOCOM”), illustrates exemplary interactions of send and receive communications at and between the various components of the TPO effected by conversion into a common format. The TPOCOM includes Sender 1710 and Receiver 1720 modules that enable messaging and interactions of data and recommendations are controlled by a TPOCOM Manager 1715. The TPOCOM Manager schedules a Task Runner 1717 to request that the Sender and Receiver send and receive recommendations, predictions, alarms, and data to the TPO components. For example, the Task Runner is instructed by the TPO Manager to fetch new and updated recommendations and predictions from the TPO database. The fetched recommendations, predictions and alarms are converted into the common format and are sent to the “System Integration Facility” (“SIF”). The SIF also receives the historical and real-time building and the exogenous weather data. The SIF formats building and weather data into the common format, and pushes the data to the Receiver 1720. The Sender 1710 and Receiver 1720 modules keep track of what data has been sent and what data has been received.

The Task Runner 1717 maintains a heartbeat and handshake protocol with the SIF once per minute in order to maintain the messaging and interactivity connection between the SIF and the TPOCOM modules alive.

Additionally, the Sender module can use XML libraries to foil′ at the recommendations and predictions into the common or standardized format. This can provide a layer of abstraction to data points from disparate sources. For example, data collected from the data collector associated with a particular building can collect data in a format different from the format of data stored at the SIF. The use of XML libraries at the Sender module can format these disparate sources of data, recommendations, and predictions into a common format that is readable by different components of the system.

In another aspect of the disclosed subject matter, a method for managing one or more buildings including collecting historical building data, real-time building data, historical exogenous data, and real-time exogenous data to generate a prediction condition can also include generating a preheating recommendation in combination with the start-up and ramp-down time recommendations. As disclosed herein, preheating can including using some mechanism available for thermal storage, such as heating water and circulating the hot water into the risers of a building before the start-up of the business day, then using that preheated water to minimize the energy usage during the expensive, heavy load portions of the work day. Generating the preheating recommendation can include generating a time before the corresponding recommended start-up time at which to pump heated water into the riser circulation system of the building. The preheating recommendation can be presented 24 hours in advance of the recommended preheating time.

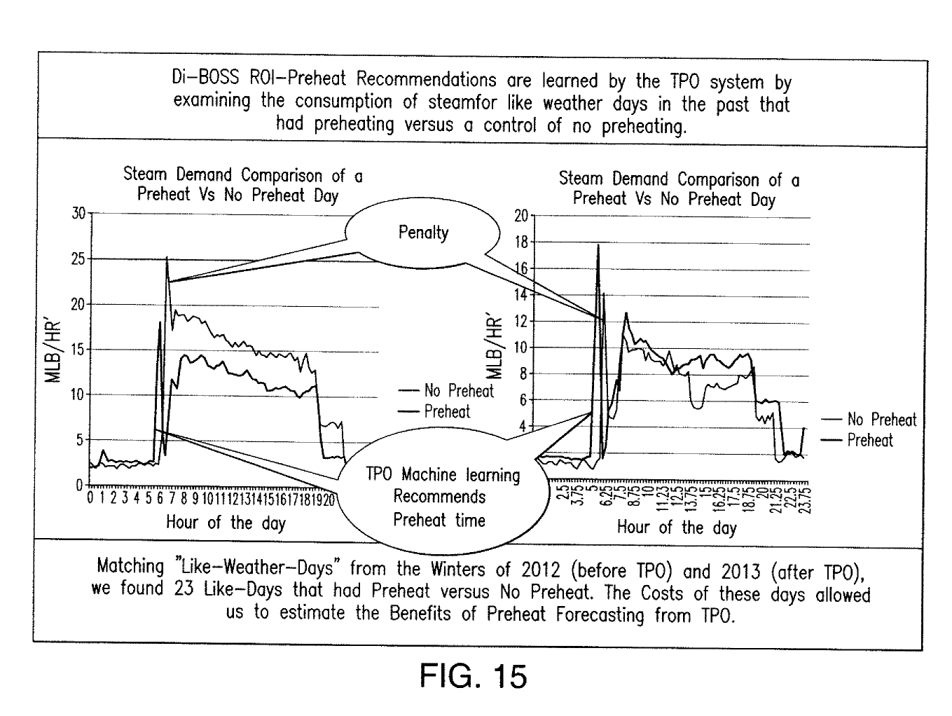

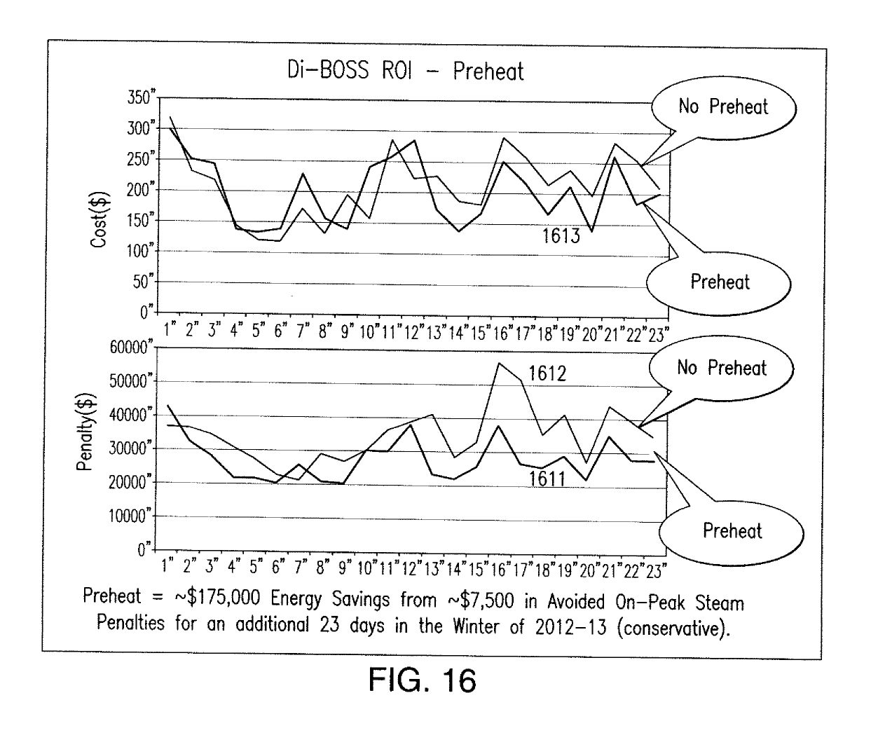

For purpose of illustration and not limitation, and with reference to FIG. 15, a TPO preheat recommendation 1511 can transfer the heating to before the peak demand time so that heavy penalties are avoided. For example, reference number 1512 illustrates an example of two mistakes that resulted in a heavy penalty. Every month in the winter utilities impose a charge for excessive demand that the preheat can minimize, as illustrated in FIG. 16. For example, FIG. 16 illustrates that TPO prestart recommendations can save a considerable amount of money per month 1611 compared to not preheating 1612. This savings in penalty is much larger than the actual cost of the additional energy 1613.

In one embodiment, the HVAC Start-Up and Ramp-down recommendations can be generated in combination with “Preheat” functionality. The Preheat functionality includes computing optimal means of heating the building before the recommended Start-Up time 412 by applying covariates such as weather, predicted weather, internal temperature recordings, and water pump and fan indicators from the BMS to a Dynamic Programming or Approximate Dynamic Programming model (which can be in certain embodiments, e.g., the Bellman Optimality Equation). Covariate data can be recorded in fifteen minute intervals. The Dynamic Programming or Approximate Dynamic Programming model can operate to reduce both current costs and future costs of steam and electricity consumption by modeling day over day transition probability distributions for the outside air temperature, the peak demand, the peak demand given the start-up time. The Preheat functionality is accomplished and the preheat is recommended to the building operator 24 hours in advance along with the Start-Up and Ramp-Down times.

The weather data can include, for example, weather data from the previous business day, the calendar day from the prior week, and the similar past weather days for which observations are available, e.g., through sensors installed on the exterior of the building, or third party data services for the surrounding micro-weather area are available, e.g., through NOAA (National Oceanic and Atmospheric Administration) or Weather Underground. These similar past weather days, for example, can be determined based on wet-bulb temperature as a metric to compare weather across days. Additionally and/or alternatively, humidex or heat index can be used to determine similar past weather days. Weather covariates can include temperature, dew point temperature, weather conditions (clear, cloudy, rain, snow, etc.) wind speed, wind direction, solar luminescent factors, heat index, pressure, and wet-bulb temperature.

In certain embodiments, start-up and ramp-down recommendations can be made by the end of business the day before. An improvement strategy can assign optimal start-up and ramp-down times to all past days (thus gaining access to the full variable set), and then learn the functional mappings between these optimal times. The start-up (and ramp-down) recommendation generator can employ the next day's weather forecast to select those learned days from the past that most closely fit tomorrow's forecast by day of the week. Every hour into the future, the actual weather can matched to the forecast weather to compute a corrected start-up and ramp-down time 24 hours into the future from that new time.

The start-up and ramp-down recommendation systems can discover the functional mapping between hourly 24-hour predictions and provide a comparison and correction based on actual recorded versus calculated times from the recent past. Optimal start-up and ramp-down times can be calculated, and can be provided as the training labels for the recommendation engine. The recommendation engine can output an updated recommendation for the next day's operation, hourly, and building operators act upon these optimal recommendations as morning and evening approach. The recommendation engine can take into account a variety of continuous feedbacks, e.g., the operators' actual actions taken, and the system responses, e.g., the space temperature curve due to the set-points adjustment, the fan speed change, and the thermal inertia, and provides more accurate recommendations for the next period.

Over each following day there can be a shift in the way the building start-up and ramp-down times are recommended. The degree of this shift can depend on how sub-optimal the past start-up and ramp-down have been. The system can then compute, from a shift in the temperature and energy use of each day, optimal building operations for the next day. As each shift takes place, the 24-hour predictions can begin to learn the new system, and adapt appropriately, predicting with each passing day, time-series data that represents the operation under the optimal conditions.

The original optimization calculations used to identify past optimal start-up and ramp-down times can begin to operate off of each newly past dataset. Since the optimization is based on a model that finds the thermodynamic response of each floor of the building to various similar start-up and ramp-down times from the past, and computes the cost-optimal solution for the future, it can either agree with the current history-based strategy, or discover a new strategy. Thus, the layered nature of the TPO recommended system, and the nature of the TPO optimization can drive the system to converge to the optimal building operation strategy.

The start-up and ramp-down generator can rely on various forms of input data. For example, the start-up and ramp-down generator can rely on 24-hour predictions. A separate energy forecasting module of the TPO machine learning suite can use a variety of covariates to predict 24-hour forecasts for space temperature, steam use, and electricity use, amongst others. By using this as a start-up and ramp-down covariate set, these 24-hour ahead predictions can correlate and map to actual performance. In using 24-hour predicted values for energy as covariates, an abstract covariate set can be included in predictions; intrinsically, covariates like occupancy, outside weather and holidays can be included by use of the 24-hour predictions, since they use those variables in their forecasts.

Additionally, a number of covariate generation methods can be used. The nature of the data set as time series data can allow for robust covariate generation. Generation techniques can look at trajectories (relative change over varying timescales), volatility, total change in values, percentage of maximum, and more in generating the parameter set to identify the classification function tying the input variables to the output time. Beyond also using such time series derived data, single variable covariates like time of day and the raw values of the past prediction accuracy can be used.

Additionally, in certain embodiments, kernelized support vector machine (SVM) classification can be used. To map the 24-hour prediction data to the provided start-up times, the learning task can be framed as a classification problem. Given times for start-up and ramp-down, the prediction data corresponding to the times before the start-up and ramp-down times can be labeled, for example, as class=−1, and all of the values after as class=1. The recommended times can be determined through a process of decision boundary discovery, where interpolation can be used to find, at minute granularity, the recommended start-up and ramp-down times.

SVM classification can be employed to generate an estimate of the optimal decision boundary. SVM classification can use the concept of maximizing a dividing hyper-plane as the methodology to learn the functional mapping between the input and output spaces. Through use of a radial basis function (RBF) kernel, the ‘kernel trick’ can be employed to account for and discover the nonlinear relationship between input variables and output predictions. For example, in certain embodiments, a grid-search can be executed to find optimal parameters on every run, and covariate scaling and k-fold cross validation can be used in the parameter optimization.

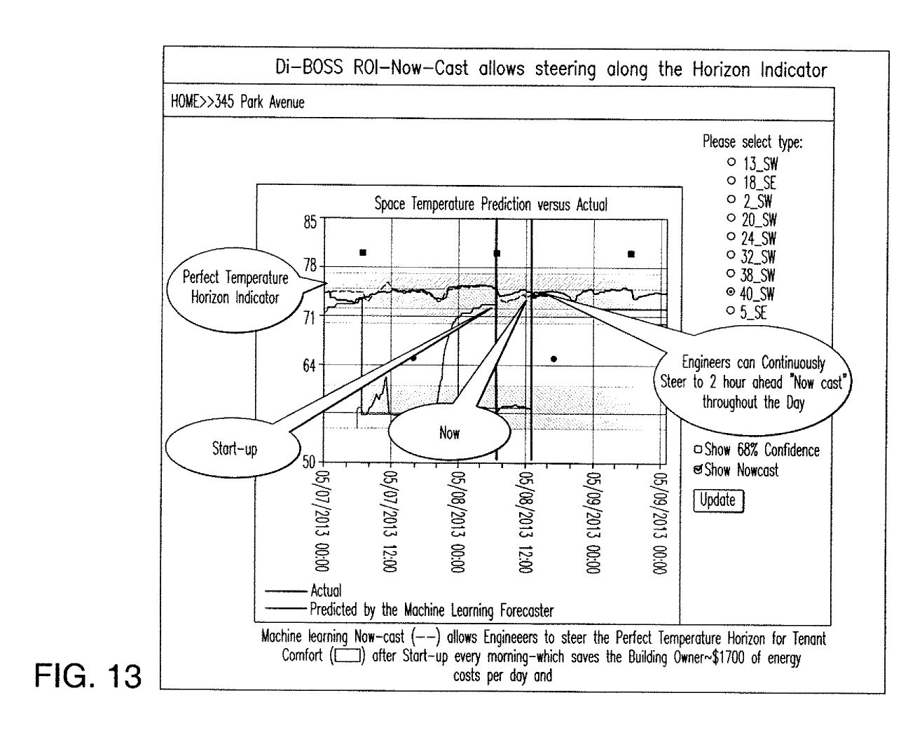

In another aspect of the disclosed subject matter, the Horizon Indicator can be adapted to provide a forecasting module that can predict the next two to four hours for floor-by-floor temperature resulting from steering by the operator of HVAC system set point values to maintain appropriate and cost-effective building conditions. In other words, there can be a direct cause and effect measured between the forecast change in temperature and the actual change in HVAC fan and chilled water set points. A module, hereinafter referred to as “Now-Cast,” can enhance the functionality of the Horizon Indicator by overlaying it with HVAC supply air information as well as command and control operability of the HVAC system. The Now-Cast module can apply BMS data as well as other covariates to the Support Vector Machine learning system (which can be, e.g., SVR or a linear regression) to learn the thermodynamic responses of each floor to HVAC set point changes. Additionally or alternatively, the Now-Cast module can apply BMS data and other covariates to other machine learning systems, such as systems based on a rule based system, neural network, fuzzy logic control, model predictive control, stochastic programming, linear programming, integer programming, mixed integer nonlinear programming, machine learning classifier, logistic regression, or the like, and/or any combination thereof. As depicted in FIG. 13, the 24 hour TPO forecast 1311 can be augmented in the Now-Cast by the tracking of supply air temperature and fan set points 1312. The two to four hour forecast into the future can be based upon the present HVAC settings for that floor 1313 to provide the operator with a visualization of the result on the floor from his action in the engine room. The actual temperature two hours later can be compared to the forecast from the Now-Cast 1314 and a performance score can be automatically recorded. In addition to the covariates listed in Table 1, other covariates can include current occupancy, outside weather, and tenant response to holidays. Through the use of a RBF kernel, the Now-Cast module can account for and discover the nonlinear relationship between input variables and output predictions.

The Now-Cast module can generate response predictions of each floor two hours into the future as time series data. This is an improvement over the Horizon Indicator alone, which is designed to predict responses 24 hours into the future without communication with the HVAC system. In this embodiment, it is possible for operators to respond to the two-hour-ahead predicted responses for each floor using the Now-Cast module. The predicted responses can be updated every hour.

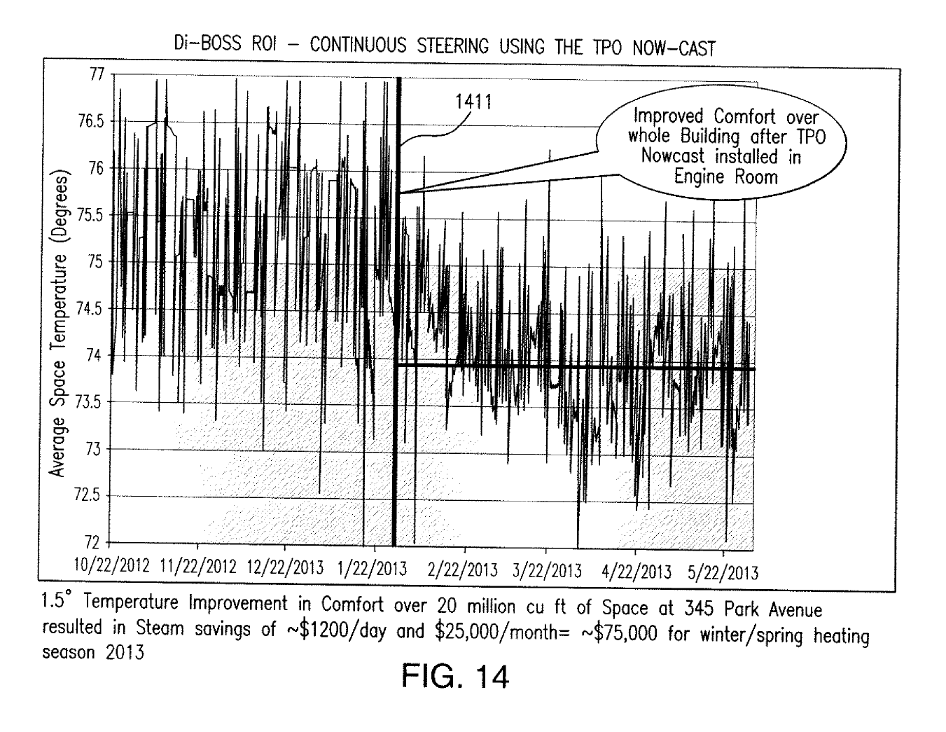

In an exemplary embodiment, with reference to FIG. 13 and FIG. 14, the Now-Cast module of the Total Property Optimizer (TPO) can be a human-in-the-loop system, which can use advanced analytics to provide building operators with the ability to steer the building to the most efficient energy comfort level floor-by-floor. The Now-Cast module of TPO uses its Support Vector Machine learning system to learn the thermodynamic response of each floor to HVAC set point changes, and uses supply air and return air temperatures along with real-time monitoring of space temperatures on each floor to steer the floor using the TPO Horizon Indicator (as illustrated in FIG. 13).

In this exemplary embodiment, ultimate control is left in the hands of the building operators, who utilize specific control levers, most often in temperature set point values, to maintain the individual floor space temperatures. In certain embodiments, however, control can be automated. The Now-Cast module can take those set points and the history of floor-by-floor performance in similar weather conditions to forecast the response of each floor two hours into the future to the now-settings.

The Now-Cast space temperature trajectory suite of machine learning can sit atop a primary layer of 24-hour predictions, and gives insights into and makes predictions about the effects of the current setting of the buildings temperature values and the values of the building operator's control levers on ambient space temperature. Utilizing both historical and predicted data, it uses a blend of relevant covariates to guide the building operators in ensuring their decisions will not break tenant lease requirements. Each run of the suite provides temperature predictions for 2 hours, resulting in 8 predictions (at 15 minute resolution) per floor.

In an exemplary embodiment, The Now-Cast module can use a space temperature trajectory machine learning suite that relies on 3 forms of input data: (i) real-time space temperature values; (ii) levers of control; and (iii) 24-hours predictions. The real-time BMS data feed can provide a view of the current temperature of the air in critical parts of the building. Thermodynamic modeling can allow the Now-Cast to identify correlative relationships between the various air and water temperature HVAC settings and the ambient space temperatures. The real-time BMS data can also provide a view of the current set point values for a variety of the engineering team's control systems. These can be in the form of thermostat set point values. A separate module of the TPO machine learning suite can use a variety of covariates to predict 24-hour forecasts for space temperature, steam use, and electricity use, amongst others. By using the predictions for space temperature, TPO can learn the past thermodynamic response of the normal operations of the building, floor-by-floor. Adding the 24-hour forecast predicted values to this past history, TPO can include an abstract covariate set into the Now-Cast predictions. Intrinsically, the Now-Cast includes covariates like current occupancy, outside weather and tenant response to holidays.

The nature of the Now-Cast as time series data can allow for robust covariate generation. Current generation techniques look at trajectories (relative change over varying timescales), volatility, total change in values, and percentage of maximum to generate the parameter set to identify the regression function tying all of the input variables and control levers to the output space temperatures two-hours into the future. Beyond time-series derived data, single variable covariates like current time of day and current temperature values can also be used.

The Now-Cast space temperature trajectory suite can use kernelized support vector regression to make TPO's estimates of temperatures in the near-term future. Support vector regression is a regression derivative of the support vector machine classification algorithm, which can use the concept of maximizing a dividing hyper-plane as the methodology to learn the functional mapping between the input and output spaces. Through use of a Radial Basis Function (RBF) kernel, the Now-Cast can employ the ‘kernel trick’ to account for and discover the nonlinear relationship between input variables and output predictions. A daily grid-search can be used to find optimal parameters, and uses such staples as k-fold cross validation in this parameter optimization.

The resulting usage of the TPO Now-Cast in the engine room by operators an exemplary high-rise office building is shown in FIG. 14. Over the winter heating season, the average space temperatures for the 44 floor, approximately 2 million square foot High-Rise office building were steered into the Horizon Indicator. 1.5 degrees F. of overheating for the 20 million cubic feet of tenant space was eliminated, resulting in a conservative estimate of savings of approximately $75,000 from a 7% reduction in energy consumption, as illustrated by the change in metrics from the left side of vertical line 1411 and the right side of vertical line 1411.

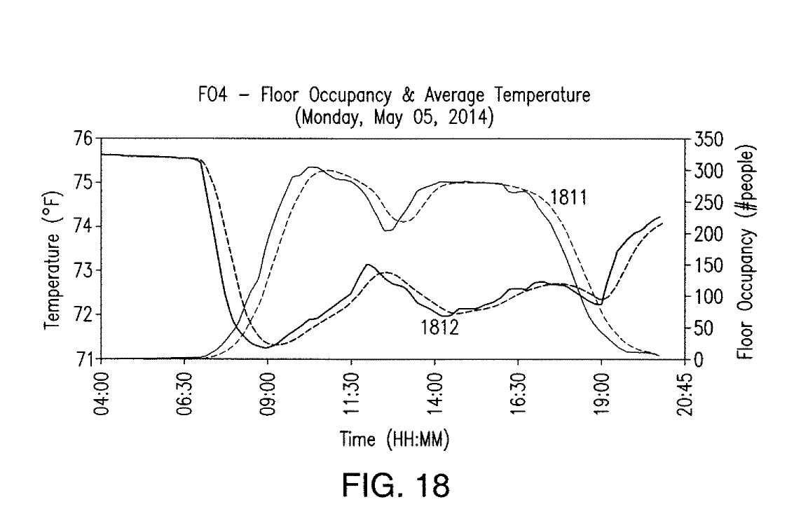

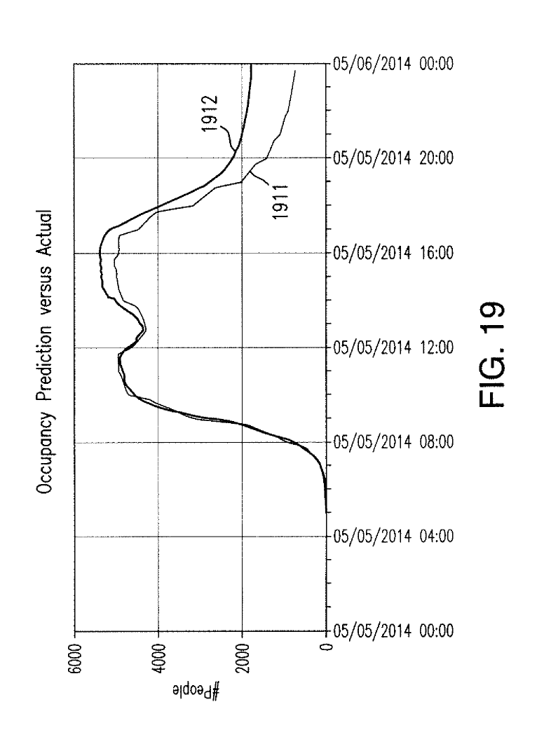

In connection with an exemplary embodiment, and with reference to FIG. 18 and FIG. 19, the disclosed subject matter can include predicting floor-by-floor occupancy to forecast occupancy and the electrical, steam and/or gas usage required to provide comfort temperatures required by tenant leases. For example, TPO can predict Floor-by-Floor Occupancy calculated from operational data from the Elevator system of each building, optionally combined with covariates disclosed herein, to forecast comfort and energy usage for specific tenants over one or multiple floors.

TPO can calculate a time series of occupancy floor-by-floor in terms of the number of people on that floor at each time-step. The number of people 1811 can calculated in real-time, as illustrated in FIG. 18, from elevator data such as when each elevator visits each floor when going up for adding people to the floor population and going down for subtracting people from the floor population utilizing changes in weight getting on and off, timing of the doors opening and closing, destination floor number entered into a scheduling panel, a security badge scanned for access permission to that floor, or any other elevator data that the TPO machine learning system can determine as relevant to that population determination. The weight can be determined from the average airlines use to estimate total passenger weights, currently 200 lbs each. As can be seen from FIG. 18, the fourth floor of a representative skyscraper can have up to 300 people present in the morning. During the lunch hour, the population can drop to about 200 as people go and come back from lunch. In the afternoon, the population can begin to decrease as workers go home beginning about 4 pm. This pattern can be repeated floor by floor, but with a varying population total per floor that is controlled by the type and density of personnel required by each tenant. For example, floor 5 has a somewhat different population pattern as depicted in FIG. 18, as does the total population of the representative building, which peaks at approximately 5500 people at 3 pm on May 5, 2014.

The TPO machine learning system can use past floor-by-floor occupancy variations over time and the space temperature variation 1812 in that same floor, in combination with weather forecast, day-of-week, and proximity-to-holidays to forecast occupancy and the electrical, steam and/or gas usage required to provide comfort temperatures required by tenant leases. For example, FIG. 19 illustrates the predicted occupancy 1911 versus actual occupancy 1912 for an exemplary building with multiple floors in accordance with the techniques described herein.

### EXAMPLES

As previously noted, and in accordance with the disclosed subject matter, the techniques described above can enable improved energy, environment and operational efficiency and reliability of building systems. The disclosed subject matter is further described by examples, presented below. The use of these examples is illustrative only and in no way limits the scope and meaning of the disclosed subject matter or any exemplified term.

### Example #1

[Note: Add Description of FIG. 4 Cost Savings] In this Example, the operations dashboard for the total property optimization system (TPO) for office building management was employed for management of multiple large buildings for commercial tenants. Buildings in the property portfolio ranged from a 2 million square foot skyscraper to a 300,000 square foot office building in Manhattan. The Horizon Indicator included real time displays of space, supply, and return air temperatures/relative humidity by HVAC zone and floor for each building. Any departures from horizontal, stable “comfort zones” defined by the tenant leases were flagged as outliers. The Horizon Indicator was implemented in the largest office building—monitoring interior space temperatures from Floors 5, 18, 32, 33, and 40 of the 44 floor building. Interior space temps from floors 24, 25, 26, and 27 were recorded shortly thereafter. Afterwards, the disclosed system began receiving interior and perimeter space temperatures from Floors 2, 13, 20, 35, and 38. During a heat wave, excess temperatures were identified on Floors 2SW and 35SW and NW. The anomalies also showed up on Floor 18NW during more normal summer temperatures.

The Horizon Indicator within the TPO enabled identification of which floors were too warm based on their continuous space temperature trends compared to lease requirement comfort levels. This prompted an investigation into possible causes for the poor performance in these areas. A traverse was performed on each of the floors revealing tears in the ducts in two places. The Cubic Feet per Meter (CFM) duct outputs were measured in all troubled regions, often revealing lower than specified CFM outputs which would be the cause of high temperatures. Causes were tears in the ducts (two cases), a dirty coil, and out of balance dampers (three cases).

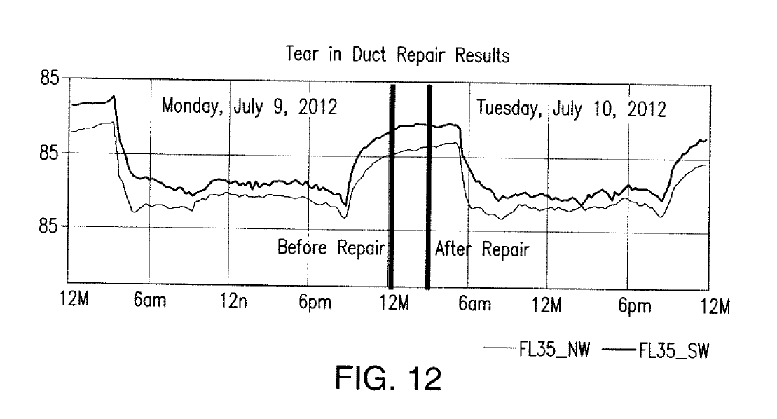

In the two regions where tears in ducts were identified, the tears were repaired overnight. After the tear was repaired the CFM output in the two areas improved, as demonstrated in table 2 and table 3 and FIG. 12.

TABLE 2
HIGH SPACE TEMPERATURE INVESTIGATION

| Location | Scheduled CFMs | Measured CFMs | Problem |
|---|---|---|---|
| 2 SW | 8700 | 14196 | Dirty coil |
| 5 NW | 8700 | 12500 | Potential Open |
| | | | Damper |
| 18 SE | 3900 | 5050 | Potential Open |
| | | | Damper |
| 18 NW | 3900 | 2490 | Potential Open |
| | | | Damper |
| 35 NW | 4200 | 3600 | Tear in duct |
| 35 SW | 3900 | 3540 | Tear in duct |

TABLE 3
TEAR IN DUCT REPAIR RESULTS

| Location | Scheduled CFMs | Pre-Repair CFMs | Post-Repair CFMs |
|---|---|---|---|
| 35 NW | 4200 | 3600 | 4013 |
| 35 SW | 3900 | 3540 | 3752 |

Thus, this example demonstrates that the TPO with its Horizon Indicator can facilitate identification of operational inefficiencies caused by maintenance problems. It can lead building operators to identify causes of such inefficiencies, revealing needed repairs that can be learned by the decision algorithm system within the TPO so that improvements in the efficiency of the building resulted, all before the tenant was even aware of a problem.

### Example #2

In this example, with reference to FIG. 15 and FIG. 16, preheat functionality as disclosed herein is described with reference to building start-up for a building in New York City. New York City's steam system can supply approximately 27 billion pounds a year to heat, cool, and power Manhattan buildings. Many commercial buildings use steam to meet their space temperature requirements. Contractually, landlords can be required maintain a space temperature within a specific range during the workday. As a result, peak demand for steam in New York can occur during the colder months of the year. The provider of these steam services can charge an additional on-peak fee for steam demanded between the hours of 6 and 11 in the morning from December to March, as the workday begins. For example, the on-peak-fee could be equal to $1,629 times the maximum rate of steam, measured in million pounds per hour (Mlb\hr), demanded during on-peak hours within a billing cycle between December and March.

To reduce this charge during building start-up building managers can heat the building using steam before a start-up time, e.g., 6 am. By storing energy generated by steam before 6 am, they “preheat” the building using an effective Hydro-Battery. That is they pump heated water into the riser circulation system of the building before 6 am and return the hot water to the HVAC system after 6 am at little additional cost. For example, if the maximum rate of steam demanded before 6 am is greater than the maximum rate demanded between 6 and 11 am, the building has been “preheated”, and the cost of that off-peak-fee steam is 100 times cheaper.

An example of preheat during building start-up is depicted in FIG. 15. These graphs come from an example high-rise building. Typically, building managers preheat each day during the on-peak winter heating months. The two dates in each plot have similar weather based on their heat indexes. In each plot, a spike occurs each day before 7 am. To store heat, building managers turn on water pumps to fill the vertical riser pipes with hot water. This sudden increase in demand for heat results in a steam demand spike. To release the stored heat, building managers turn on the HVAC fans that then circulate air heated by the hot water throughout the building. On preheat days, steam demand spikes occur before 6 am. One can observe that preheat does not always result in a greater daily steam consumption or spike in steam usage.

Given these temperature and peak demand penalties, building managers are not necessarily adequately informed concerning methods to reduce steam demand and steam costs during these on-peak months. A TPO preheat objective, therefore, is to compute the optimal means of heating the building that reduces steam demand and reduces cost and recommend that the day before to building operators.

In this example, the TPO system can use as Support Vector Machine learning covariates data going back as far as January 2012, which includes weather, predicted weather, internal temperature recordings, and water pump and fan indicators from the Building Management System. Data is recorded in fifteen-minute intervals.

The example building is likely to incur its on-peak-fee on weekday mornings between December and March. TPO has learned from 23 like weather days in which the building managers have not attempted to preheat, and matched them with 23 preheat days of similar weather. These matched days are based on heat index. Using the energy usage, TPO approximated the total cost for each day based on the steam service provider's billing structure, and whether an on-peak penalty charge was incurred that day. As FIG. 16 shows, steam usage is similar for the like weather days, but the on-peak penalty greatly exceeds the preheat steam cost making for an approximate Return-on-Investment (ROI) of $175,000 in saving for the winter of 2012-2013 if TPL Preheat recommendations would have been enacted.

Table 4 provides an exemplary Return on Investment statistical test of 23 days of preheating before 6 am compared with a control group of like weather days but with no preheating. In Table 4, a Permutation Test on the Preheat test group versus the No preheat control group yields a probability of statistically different results of p=0.27 for cost of the steam used (not statistically different), but p=0.004 that Preheat is a non-random improvement in performance over the control group (the Preheat group is statistically different from the control group). While the difference in average steam usage is not statistically significant, the average steam cost is significantly lower for preheat days because of the elimination of on-peak steam usage penalties. These tests suggest that through preheating alone, building managers can significantly decrease energy costs during building start-up while using similar amounts of steam energy.

TABLE 4

| | No Preheat Control Group | Preheat Test Group | Permutation Test |
|---|---|---|---|
| Steam Cost ($) | $211 | $201 | p = 0.267 |
| Penalty Charge ($) | $35,105 | $27,774 | p = 0.004 |

| | | Penalty Charge | | | |
|---|---|---|---|---|---|
| Dates (No Preheat) | Steam Cost (No Preheat) | (No Preheat) | Dates (Preheat) | Steam Cost (Preheat) | Penalty Charge (Preheat) |
| Jan. 19, 2012 | $317 | $37,099 | Feb. 9, 2011 | $299 | $42,875 |
| Feb. 9, 2012 | $232 | $36,906 | Jan. 27, 2011 | $250 | $32,661 |
| Feb. 20, 2012 | $218 | $34,692 | Dec. 13, 2012 | $244 | $28,405 |
| Mar. 26, 2012 | $145 | $30,727 | Dec. 3, 2012 | $138 | $22,212 |
| Mar. 28, 2012 | $121 | $27,473 | Feb. 17, 2011 | $133 | $21,812 |
| Mar. 29, 2012 | $118 | $23,042 | Dec. 22, 2011 | $139 | $20,493 |
| Dec. 5, 2012 | $172 | $21,355 | Feb. 2, 2012 | $229 | $25,995 |
| Dec. 10, 2012 | $132 | $29,319 | Dec. 21, 2011 | $157 | $20,933 |
| Dec. 11, 2012 | $195 | $27,097 | Dec. 22, 2011 | $139 | $20,493 |
| Dec. 18, 2012 | $156 | $30,341 | Feb. 16, 2012 | $241 | $30,378 |
| Dec. 27, 2012 | $285 | $36,581 | Jan. 29, 2013 | $257 | $30,104 |
| Jan. 9, 2013 | $223 | $39,030 | Mar. 31, 2011 | $285 | $38,233 |
| Jan. 10, 2013 | $227 | $41,140 | Dec. 15, 2011 | $171 | $23,555 |
| Jan. 14, 2013 | $187 | $28,406 | Dec. 3, 2012 | $138 | $22,212 |
| Jan. 30, 2013 | $181 | $32,948 | Feb. 28, 2011 | $165 | $25,559 |
| Feb. 6, 2013 | $290 | $56,594 | Jan. 4, 2011 | $251 | $38,249 |
| Feb. 12, 2013 | $259 | $51,506 | Jan. 12, 2012 | $216 | $26,688 |
| Feb. 28, 2013 | $214 | $35,568 | Feb. 28, 2011 | $165 | $25,559 |
| Mar. 11, 2013 | $237 | $41,570 | Dec. 14, 2012 | $212 | $29,309 |
| Mar. 12, 2013 | $195 | $27,220 | Dec. 3, 2012 | $138 | $22,212 |
| Mar. 21, 2013 | $282 | $44,115 | Feb. 10, 2012 | $260 | $35,079 |
| Mar. 28, 2013 | $255 | $39,580 | Dec. 2, 2011 | $184 | $28,003 |
| Averages | $211 | $35,105 | | $201 | $27,774 |

The TPO system can form the decision analysis tool for a system of systems that integrates simulation models, machine learning, approximate dynamic programming, statistical diagnostics, and capital asset planning for the building, property portfolio, campus, microgrid, military base, or the like. The TPO can provide techniques for treating uncertainty from both operational and financial standpoints, simultaneously.

As described above in connection with certain embodiments, certain components, e.g., 300, 310, 315, 320, and 332, can include a computer or computers, processor, network, mobile device, cluster, or other hardware to perform various functions. Moreover, certain elements of the disclosed subject matter can be embodied in computer readable code which can be stored on computer readable media and when executed cause a processor to perform certain functions. In these embodiments, the computer plays a significant role in permitting the system and method to manage one or more buildings. For example, the presence of the computer, processor, memory, storage, and networking or hardware provides the ability to provide real time feedback from sensors and other data sources for the purpose of improving electric, steam and/or fossil fuel load forecasts and generating executable recommendations related to tenant comfort and building maintenance problems.

Additionally, as described above in connection with certain embodiments, certain components can communicate with certain other components, for example via a network, e.g., the internet or intranet. To the extent not expressly stated above, the disclosed subject matter is intended to encompass both sides of each transaction, including transmitting and receiving. One of ordinary skill in the art will readily understand that with regard to the features described above, if one component transmits, sends, or otherwise makes available to another component, the other component will receive or acquire, whether expressly stated or not.

The techniques disclosed herein can allow for cost effective, efficient and environmentally sound management of building systems. For purposes of illustration and not limitation, an exemplary embodiment is described herein. It should be apparent, however, to those skilled in the art that many more modifications besides those described herein are possible without departing from the concepts of the disclosed subject matter.

1. A method for managing one or more buildings, comprising:
collecting historical building data, real-time building data, historical exogenous data, and real-time exogenous data;
receiving the collected data at an adaptive stochastic controller; and with the adaptive stochastic controller:
identifying trends based on the collected data of the one or more buildings;
generating at least one of a predicted condition with a predictive model;
generating one or more executable recommendations based on the predicted condition and one or more performance measurements corresponding to the executable recommendations;
displaying on a graphical user interface the one or more trends based on the collected data of the one or more buildings, the one or more predicted conditions, and the one or more executable recommendations; and
generating suggestions to an operator via the graphical user interface to manually steer a floor condition of the said one or more buildings in response to the one or more trends, predicted conditions, or executable recommendations displayed on the graphical user interface.

2. The method of claim 1, further comprising communicating with the one or more buildings' HVAC systems to automatically steer the floor condition of the said one or more buildings in response to the one or more trends, predicted conditions, or executable recommendations displayed on the graphical user interface.

3. The method of claim 1, wherein the predicted condition includes at least one of the group of predicted space temperature, supply air temperature, chilled water temperature, electric load, steam consumption or fuel consumption.

4. The method of claim 1, wherein generating the at least one predicted condition includes predicting floor-by-floor occupancy and energy usage over multiple floors. The method of claim 1, wherein collecting further comprises receiving from a building management system the historical building data, real-time building data, historical exogenous data, and real-time exogenous data, and wherein the historical building data and the real-time building data includes electric data, fuel and steam data, space temperature information, air flow rate data, chilled water temperature data, supply air temperature information, return air temperature information, lighting sensor data, elevator data, carbon dioxide data, and HVAC system control data.

5. The method of claim 1, wherein collecting further comprises querying one or more databases including the historical building data, real-time building data, historical exogenous data, and real-time exogenous data.

6. The method of claim 1, wherein collecting further comprises receiving over a network at least one of the historical exogenous data and the real-time exogenous data, and wherein the historical exogenous data and the real-time exogenous data include at least one of historical weather data, forecast weather data, and power grid data.

7. The method of 1, further comprising identifying trends in the one or more building conditions and generating a predicted condition for each building condition, and displaying the identified trends and the predicted conditions, whereby an operator is alerted when an anomaly between the predicted conditions and the building conditions arises.

8. The method of claim 7, wherein the one or more building conditions include space temperature at each measurement location of each floor in the one or more buildings.

9. A method for managing one or more buildings, comprising:
collecting historical building data, real-time building data, historical exogenous data, and real-time exogenous data;
receiving the collected data at an adaptive stochastic controller; and with the adaptive stochastic controller:
generating at least one of a predicted condition with a predictive model;
generating one or more executable recommendations, which includes generating at least one of a recommended start-up time and ramp-down time for a HVAC system based on at least the trends in the one or more building conditions; and
generating a one or more preheat conditions.

10. The method of claim 9, wherein generating one or more executable recommendations further includes generating at least one of a recommended start-up time and ramp-down time for a HVAC system based on at least the trends in the one or more building conditions, the predicted conditions, and the performance measurements.

11. The method of claim 9, wherein generating the one or more preheat conditions includes reducing costs of steam and electricity consumption determined by applying the collected data and the one or more predicted conditions to a dynamic programming or approximate dynamic programming model.

12. A system for managing one or more buildings, comprising:
a data collector to collect historical building data, real-time building data, historical exogenous data, and real-time exogenous data;
an adaptive stochastic controller operatively coupled to the data collector and adapted to receive collected data therefrom, the adaptive stochastic controller configured to generate at least one predicted condition; and
at least one communications module communicatively coupled the data collector, the adaptive stochastic controller, and a System Integration Facility server via a bi-directional messaging interface, wherein the communications module comprises a processor and a memory having computer-executable instructions which, when executed by the processor, cause the processor to:
receive data from the System Integration Facility server;
convert the data from the System Integration Facility server and the collected data to a standardized format;
store the data from the System Integration Facility server in a database;
send the collected data and the data from the System Integration Facility server to the adaptive stochastic controller to generate the at least one predicted condition or recommendation;
store the at least one predicted condition or recommendation in the database; and
send the at least one predicted condition or recommendation to the System Integration Facility server.

13. The system of claim 12, wherein the communications module maintains a connection to the System Integration Facility server by one or more of a handshake and heartbeat protocol.

14. The system of claim 12, wherein the predicted condition includes at least one of the group of space temperature, supply air temperature, chilled water temperature, electric load, steam consumption or fuel consumption

15. The system of claim 12, wherein the data collector is operatively coupled to a building management system, and wherein the historical building data and the real-time building data includes data from at least one of electric meters, fuel and steam sub-meters, chilled water temperature sensors, space temperature and space humidity sensors, supply air temperature and supply air humidity sensors, air flow rate sensors, return air temperature and humidity sensors, or carbon dioxide sensors.

16. The system of 12, wherein the adaptive stochastic controller is further configured to generate at least one of a recommended start-up time and ramp-down time.

17. The system of claim 12, wherein the adaptive stochastic controller is further configured to generate at least one of a recommended start-up time and ramp-down time based on the at least one predicted condition.

18. The system of claim 12, wherein the adaptive stochastic controller is further configured to generate an alarm indication by identifying aberrational conditions and wherein the processor is further configured to:
store the alarm indication in the database; and
send the alarm indication to the System Integration Facility server.
